(19) United States
(12) Patent Application Publication
(10) Pub. No.: US 2024/0222594 A1
(43) Pub. Date: Jul. 4, 2024

(54) ELECTRODE FABRICATION PROCESS

(71) Applicant: Sakuu Corporation, San Jose, CA (US)

(72) Inventors: Nojan ALIAHMAD, San Jose, CA (US); Ming LI, San Jose, CA (US); Stephen RUDISILL, San Jose, CA (US); Karl LITTAU, Los Altos Hills, CA (US); Jin ZHENG, San Jose, CA (US); Zhi QIAO, San Jose, CA (US); Samuel CASTRO, San Jose, CA (US); Mohammadamin MOGHADASI, San Jose, CA (US); Mohammad SAJADI, San Jose, CA (US); Ali Jamal KHAN, San Jose, CA (US); Lizett ACOSTA, San Jose, CA (US); Jim RITTER, San Jose, CA (US); Sadeq SALEH, San Jose, CA (US); Kyle GAMELIN, San Jose, CA (US)

(73) Assignee: Sakuu Corporation, San Jose, CA (US)

(21) Appl. No.: 18/391,024

(22) Filed: Dec. 20, 2023

Related U.S. Application Data
(60) Provisional application No. 63/435,094, filed on Dec. 23, 2022.
(60) Provisional application No. 63/435,245, filed on Dec. 24, 2022.

(51) Int. Cl. H01M 4/04; B05C 19/00; B05C 19/04; H01M 4/02; H01M 4/139; H01M 4/36; H01M 4/62

(52) U.S. Cl. CPC H01M 4/0404; B05C 19/008; B05C 19/04; H01M 4/0435; H01M 4/0471; H01M 4/139; H01M 4/366; H01M 4/623; H01M 2004/021

(57) ABSTRACT

A method for manufacturing a battery electrode includes mixing particles of active electrode materials, conductive additives, and binder to form a dry powder electrode material. The dry powder is then deposited onto a moving electrode current collector using a dry powder dispensing device. The dry powder is a loose powder continuously poured from the dispensing device onto a moving current collector in a roll-to-roll system where the powder remains loose on the current collector as it travels towards a compaction stage. After being poured onto the current collector, the loose dry powder is uniformly spread across the width of the moving current collector web by one or more spreading devices, such as smoothing rollers and conditioning rollers. Finally, the dry powder is compacted using a calender configured to apply pressure and/or heat to the dry powder electrode material to activate the binder and form a battery electrode.

### TECHNICAL FIELD

The present disclosure is related generally to electrode manufacturing processes, and, in particular, to dry powder electrode manufacturing processes.

### BACKGROUND

A battery includes two electrode layers—an anode and a cathode—each connected to a conductive current collector, typically made of copper or aluminum. These layers include cathode active material or anode active material mixed with one or more conductive materials and a binder to form a structure that readily charges and discharges during battery operation. The selection of the active materials, binder, and conductive material can vary depending on the desired chemistry, application, and method of production.

Common approaches to battery manufacturing employ a wet coating process to form the electrode layers. The wet coating process involves forming a slurry by mixing the electrode active material, conductive material and binder in a solvent and coating the slurry onto a conductive current collector, followed by drying the coating layer to evaporate the solvent and compaction to densify the electrode structure. The most commonly used solvent is N-methyl-2-pyrrolidone (NMP), which is toxic and must be recaptured after evaporation and further purified through distillation for reuse. Both the drying and solvent recovery require large manufacturing footprint and energy consumption, leading to high manufacturing cost.

Solvent-free approaches to form the electrode layers from a dry active material powder have been proposed. This includes using electrostatic deposition to spray the active material, conductive materials, and a binder onto the conductive current collector. Active material particles, conductive material, and binder particles are aerated or aerosolized by a pressured gas flow. The gas flow carries the fluidized particles through an electrostatic applicator where they are charged by an electric field and then deposited on a grounded conductive current collector. The electrostatic forces cause the charged particles to adhere to the grounded current collector, making the active material, conductive materials, and binder easier to handle prior to compaction. Electrostatic deposition, however, tends to result in non-uniform layers due to electrostatic forces acting on some particles more than others, resulting in particle sedimentation (e.g., uneven particle distribution along an axis normal to the current collector surface). The gas flow is also achieved using forced air that tends to result in non-uniform surface thicknesses and unnatural settling of particles on the substrate often characterized by a wave or stripe pattern across the layer's surface. These non-uniformities cause uneven current distribution during battery charge and discharge across the layer that negatively affect cycle life as the current overuses areas of lesser resistance. Also, containment and safety issues arise with this deposition technique since forced air is used to spray a powder.

Accordingly, a process for forming an electrode layer that is uniform in thickness and particle distribution without the use of solvents is desirable.

### SUMMARY

A method for manufacturing a battery electrode is disclosed. The method includes mixing dry particles of one or more electrode active materials, conductive additives, and one or more binder materials to form a binder-coated dry powder electrode material. The binder-coated dry powder electrode material can be for a cathode or an anode. The dry powder electrode material is then deposited onto an electrode current collector substrate using a dry powder dispensing device. In various examples, the dry powder electrode material is a loose powder that can be poured from the dispensing device onto a moving current collector web in a roll-to-roll system. The dry powder electrode material remains loose on the current collector web after deposition as it travels towards a compaction stage.

After being poured onto the current collector, the loose dry powder electrode material is uniformly spread across the width of the moving current collector web by one or more spreading devices. The one or more spreading devices may include a doctor blade, one or more counter-rotating smoothing rollers, and one or more forward-rotating conditioning rollers. Additionally, in at least one embodiment, the one or more spreading devices operate in coordination with the chosen materials on the moving current collector web to create and maintain a smooth and uniform loose powder layer that is sufficiently cohesive up and until compaction. Accordingly, the dry powder electrode material is compacted against the moving current collector web using a calender configured to apply at least one of pressure or heat to the dry powder electrode material to activate the binder and form a battery electrode.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example lithium metal cell for a battery, in accordance with one or more embodiments.

FIG. 2A shows an example flowable dry powder electrode material particle, in accordance with one or more embodiments.

FIG. 2B shows an example morphology of a dry powder electrode material particle, in accordance with various embodiments.

FIG. 2C shows an example morphology of a dry powder electrode material particle, in accordance with various embodiments.

FIG. 2D shows an example morphology of a dry powder electrode material particle, in accordance with various embodiments.

FIG. 2E shows an example morphology of a dry powder electrode material particle, in accordance with various embodiments.

FIG. 3A shows an example dry powder electrode manufacturing platform, in accordance with one or more embodiments.

FIG. 3B shows an example primer layer deposited on the surface of a current collector web, in accordance with one or more embodiments.

FIG. 3C shows an example roughened surface of a current collector web, in accordance with one or more embodiments.

FIG. 3D shows an example conditioning station, in accordance with one or more embodiments.

FIG. 4A shows an example double sided dry powder electrode manufacturing platform, in accordance with one or more embodiments.

FIG. 4B shows an example double sided electrode, in accordance with various embodiments.

FIG. 5 shows an example double sided dry powder electrode manufacturing platform, in accordance with one or more embodiments.

FIG. 6 is a flowchart for method of solvent free manufacturing of a battery electrode, in accordance with various embodiments.

FIG. 7A shows an example post-compaction morphology of a dry powder electrode, in accordance with various embodiments.

FIG. 7B shows another example post-compaction morphology of a dry powder electrode, in accordance with various embodiments.

FIG. 8 shows an example dry powder electrode manufacturing platform, in accordance with one or more embodiments.

FIG. 9A shows example curing process for patterned binder curing, in accordance with various embodiments.

FIG. 9B shows example curing process for patterned binder curing, in accordance with various embodiments.

FIG. 10A shows an example curing process for patterned binder curing, in accordance with various embodiments.

FIG. 10B shows another example curing process for patterned binder curing, in accordance with various embodiments.

FIG. 11A shows an example monopolar battery configuration, in accordance with one or more embodiments.

FIG. 11B shows an example bipolar battery configuration, in accordance with one or more embodiments.

FIG. 12 illustrates a flow chart for a method of manufacturing a battery cell, in accordance with various implementations.

FIG. 13 shows an example process of forming a battery using a build platform battery configuration, in accordance with one or more embodiments.

FIG. 14 shows another example process of forming a battery using a build platform battery configuration, in accordance with one or more embodiments.

### DETAILED DESCRIPTION

In the following detailed description, numerous specific details are set forth by way of examples to provide a thorough understanding of the disclosed subject matter. It may become apparent to persons of ordinary skill in the art, though, upon reading this disclosure, that one or more disclosed aspects may be practiced without such details. In addition, description of various example implementations according to this disclosure may include referencing of or to one or more known techniques or operations, and such referencing can be at relatively high-level, to avoid obscuring of various concepts, aspects and features thereof with details not particular to and not necessary for fully understanding the present disclosure.

### Overview

A method for manufacturing a battery electrode is disclosed. The method includes mixing dry particles of one or more electrode active materials, conductive additives, and one or more binder materials to form a binder-coated dry powder electrode material. The binder-coated dry powder electrode material can be for a cathode or an anode. The dry powder electrode material is then deposited onto an electrode current collector substrate using a dry powder dispensing device. In various examples, the dry powder electrode material is a loose powder that can be poured at speed or mass rate from the dispensing device onto a moving current collector web in a roll-to-roll system. The dry powder electrode material remains loose on the current collector web after deposition as it travels towards a compaction stage. The term “loose” used here is to denote that the dry powder electrode material is not maintained on the current collector web by using particular forces such as vacuum force or electrostatic force used in electrostatic deposition as described above.

After being poured onto the current collector, the loose dry powder electrode material is uniformly spread across the width of the moving current collector web by one or more spreading devices. The one or more spreading devices may include a doctor blade, one or more counter-rotating smoothing rollers, and one or more forward-rotating conditioning rollers.

Working with loose dry powders on a moving web prior to compaction is not trivial. Thus, in various examples, the constituent materials of the loose dry powder electrode material are chosen to achieve a balance between flowability and cohesion. The flowability of the loose dry powder electrode material is tuned to allow these materials to readily pour from the dispensing device, yet not too flowable that it scatters upon hitting the moving web or is easily disturbed by the movement and associated vibration of the web. Additionally, an electrode layer must be smooth and uniform in thickness after compaction and a material that is too flowable does not compact well when calendered. Attempts to compact a highly flowable material with a calender often include streaks in the direction of the moving web as the flowable powder is pushed down the current collector web by the calender or the powder slips. Conversely, if the loose dry powder electrode material is too cohesive, it comes out of the powder dispenser in clumps, does not spread well, and does not create a smooth and uniform layer when calendered or spread (e.g., there is often separation between individual clumps). Thus, the constituent materials of the loose dry powder electrode material are chosen to achieve a balance between flowability and cohesion.

However, flowability and cohesion are not the only constraints or challenges when engineering a loose dry powder electrode material. While there must be a balance between flowability and cohesion to produce a uniform layer, these materials must also be able to provide target electrochemical properties for target battery performance. Thus, a powder engineered to optimize for a balance between flowability and cohesion in powder deposition would not necessarily result in the kind of electrochemical performance necessary for a decent battery. For example, a relatively higher concentration of binder in loose dry powder electrode material formed by mixing at high shear forces has shown to result in an optimal balance of flowability and cohesion. The resulting morphology is a thick coating of binder around the active electrode material particles that was flowable; however, the relatively large amount of binder reduces the volume of pores for sufficient electrolyte penetration and the thick coating around the active electrode material inhibits ionic conduction. Additionally, excess binder can close pores in the particle network or at least deoptimize the size distribution of the pores, which is a relevant factor in electrolyte uptake. Accordingly, after several trials controlling for each of these variables, the binder concentration and the shear forces of the mixer were reduced to create a powder coating layer where the binder material was sufficiently limited as a surface adherent to the active material particle to enable sufficient electrolyte penetration. Ideally, binder would be limited to the contact points of the active material particles; however, there is a large element of randomness in the binder particle location on the active material particles and it was determined that less binder coverage around the active material particles provides improved ionic conduction.

Additionally, in at least one example, the one or more spreading devices operate in coordination with the chosen materials on the moving current collector web to create and maintain a smooth and uniform loose powder layer that is sufficiently cohesive up and until compaction. In one example, the spreading devices aid in maintaining cohesiveness at web speeds >5 meters per minute. Accordingly, the dry powder electrode material is compacted against the moving current collector web using a calender configured to apply at least one of pressure or heat to the dry powder electrode material to activate the binder and form a battery electrode.

### Battery Overview

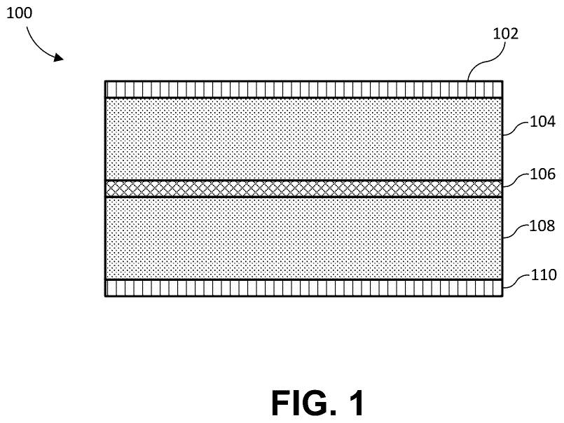

FIG. 1 shows an example of a lithium metal cell 100 for a battery in accordance with this disclosure. As used herein, a “battery” refers to any structure in which chemical energy is converted into electricity and used as a source of power. The terms “battery” and “cell” are generally interchangeable when referring to one electrochemical cell, although the term “battery” can also be used to refer to a plurality or stack of electrically interconnected cells. Lithium cell 100 of FIG. 1 includes cathode current collector 102, cathode 104, separator 106, anode 108, and anode current collector 110.

In various implementations, the anode current collector 110 comprises a plate, sheet, foil, cloth, or the like formed of a suitable conductive material. Examples of materials that may be used to form anode current collector 110 include carbon black, activated carbon, graphite, graphene, carbon fiber, and carbon nanotubes, copper, nickel, silver, carbon-polymer composite, metal-polymer composite, or combinations thereof. Anode current collector 110 may have any suitable thickness. In various implementations, anode current collector 110 is provided with a thickness in a range from 1-50 microns. In one embodiment, the anode current collector 110 has a thickness of 8 microns. The anode current collector may be used as a substrate and mechanical support for the anode electrode.

Anode 108 is composed of an anode active material adhered to anode current collector 110. In various implementations, the anode active material comprises lithium, lithium powder, molten lithium, semi-liquid lithium, lithium titanium oxide, silicon, silicon oxide, hard carbon, and graphite or combinations thereof. Anode 108 may have any suitable thickness. In various implementations, the thickness of anode 108 ranges from 3-600 microns. In one implementation, anode 108 comprises a lithium metal anode having f a thickness of 20 microns. In another implementation, anode 108 comprises a graphite anode of 70 micron thickness. Anode 108 has an inner surface in contact with anode current collector 110 and another in contact with separator 106 when cell 100 is assembled.

In one embodiment, a dry powder anode material for anode 108 is formed by mixing an anode active material (e.g., graphite) with a conductive additive (e.g., conductive carbon) in a first mixing process. In this example, the graphite selected for the anode is pearl graphite for sufficient flowability with a particle size of D50 in, for example, a range of 5-20 μm at ˜93 wt %. The conductive carbon, in this example, is 1.5 wt % with a particle size of D50 in the range of 1 nm to <1 μm. A second mixing process is then performed to mix the graphite/conductive carbon mixture with a binder, such as PVDF. Any suitable mixing process may be used for the first and second mixing processes. The dry powder anode material is then deposited onto an anode collector to a desired thickness and coverage. A compaction process is then carried out to densify the powder and melt the binder, as described later herein.

Cathode 104 is composed of a cathode active material adhered to cathode current collector 102. In various implementations, cathode current collector 102 may be in the form of a plate, sheet, foil, cloth, and the like formed of a suitable conductive material. Examples of materials that may be used to form the cathode current collector 102 include carbon black, activated carbon, graphite, graphene, carbon fiber, and carbon nanotubes, aluminum, nickel, silver, carbon-polymer composite, metal-polymer composite, or combinations thereof. Cathode current collector 102 may have any suitable thickness. In various implementations, cathode current collector 102 has a thickness in a range from 1-30 microns. In one implementation, the cathode current collector 102 has a thickness of 12 microns. The cathode current collector may be used as a substrate and mechanical support for the cathode electrode.

The cathode electrode 104 is formed of a suitable cathode active material. Examples of cathode active material include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), lithium vanadium oxide (LVO), lithium iron disulfide, silver vanadium oxide, carbon monofluoride, copper oxide, sulfur, or combinations thereof. Cathode electrode may have any suitable thickness. In various implementations, cathode 104 has a thickness of 3-600 microns depending on the desired loading.

In one embodiment, a dry powder cathode material for cathode 104 is formed using a mixing process to partially coat carbon and binder (e.g., PVDF) onto the cathode active material particles. In one embodiment, 0.5-5% binder is used in the mixing process; however, higher concentrations of 12% have been used. The resulting composite cathode powder has better dry powder flowability compared with pure cathode powder, such as NMC by itself. This enables dry powder deposition on a current collector with a controllable thickness. For this implementation, compaction (e.g., pressing or calendaring) at a pressure of 10-30 MPa was applied at a temperature between 100° C. and 250° C. to activate the binder. Separator 106 is placed between anode 108 and cathode 104 to provide electronic insulation and thus prevent short circuit between the anode and cathode. While providing electronic insulation, separator 106 must be an ionic conductor allowing the transport of ions such as lithium and sodium ions. Separator 106 may be formed of any suitable electrolyte materials including liquid electrolytes, polymer composite electrolytes, solid-state electrolytes, or combinations therefore. Separator 106 may have a thickness in a range of 5-100 microns. In various implementations, the separator can be formed separately as a freestanding layer, which is then placed between the anode and cathode. Alternatively, the separator can be formed directly on top of the anode or the cathode.

In one embodiment, the separator 106 is a freestanding polymer film or membrane having suitable porous structure allowing for the infusion of liquid electrolyte to provide lithium ion conduction through the membrane. The membrane may have a thickness in a range of 5-50 microns, a pore size in a range of 30-150 nm and porosity in a range of 30%-80%. The materials used in the membrane may include polypropylene, polyethylene, other polyolefins, nylon, cellulose, glass fiber, polyimide, PVDF, etc. Any suitable liquid electrolytes may be utilized and infused in the porous network of the membrane. The liquid electrolyte may include one or more lithium salts dissolved in one or more organic solvents including various carbonates, ethers, ionic liquids and combinations. Examples of lithium salts include lithium bis(trifluoromethanesulfonyl)imide, lithium bis(fluorosulfonyl) imide, lithium hexafluorophosphate, lithium tetrafluoroborate, lithium bis(oxalato)-borate, lithium difluoro(oxalato)borate, etc. Examples of organic solvents for dissolving the lithium salts include dimethyl carbonate, ethyl-methyl carbonate, propylene carbonate, dimethoxyethane, dioxolane, trimethyl phosphate, triethyl phosphate, tetrafluoropropylether, ionic liquids, and the like.

In another embodiment, separator 106 is a ceramic layer formed on top of the anode or cathode. The ceramic layer may have similar thickness, pore size and porosity as described above for the polymer membrane allowing for the infusion of liquid electrolyte to provide lithium ion conduction through the layer. The materials used in the ceramic layer may include aluminum oxide, silicon dioxide, titanium dioxide, zinc oxide, and the like. The ceramic layer may be formed on top of the anode or cathode by any suitable deposition methods such as powder bed printing, inkjet or jetted material printing, screen printing, electrophotographic printing, etc. For example, the ceramic layer is formed on top of the anode or cathode with a dry powder of ceramic material precoated with a binder, similar to the binder coated dry anode or cathode materials. In other embodiments, the separator 106 is a polymer-ceramic composite layer formed on top of the anode or cathode. In addition to the polymer and ceramic materials, the composite layer may comprise lithium salts to enhance the ionic conductivity.

In a further embodiment, the separator 106 is a solid-state electrolyte layer formed on top of the anode or cathode. In this case, liquid electrolyte is not required as the solid-state electrolyte can provide adequate ionic conductivity. The solid-state electrolyte layer may have a thickness in a range of 5-50 microns and porosity of less than 5%. The materials used in the solid-state electrolyte layer may include solid polymers such as polyethylene oxide, lithium lanthanum zirconium oxide and its variants, lithium aluminum germanium phosphate, lithium sulfide, and the like. The solid-state electrolyte layer may be formed on top of the anode or cathode by any suitable deposition methods such as powder bed printing, inkjet or jetted material printing, screen printing, electrophotographic printing, etc. In one implementation, the solid-state electrolyte layer is formed on top of the anode or cathode with a dry powder of solid-state electrolyte material precoated with a binder.

### Dry Powder Engineering

As described herein, the anode and cathode electrode layers are each formed using a binder-coated dry powder electrode material manufacturing process. Accordingly, the binder-coated dry powder electrode material used to produce the dry powder electrode layers is produced by dry mixing particles of one or more active electrode materials, conductive additives, and one or more binder materials. As described above, working with loose dry powders on a moving web prior to compaction is not trivial and the constituent materials of the loose dry powder electrode material are chosen to achieve a balance between flowability and cohesion. The flowability of the loose dry powder electrode material is engineered to allow these materials to readily pour from a dispensing device, but not too flowable that the powder scatters upon hitting the moving web or is easily disturbed by the movement and associated vibration of the web. Additionally, the loose dry powder electrode material cannot be too cohesive, or it dispenses in clumps and does not spread well. Thus, the constituent materials of the loose dry powder electrode material are chosen to achieve a balance between flowability and cohesion.

Flowability and cohesion, however, are not the only constraints. While there must be a reasonable balance between flowability and cohesion to produce a uniform layer, these materials must also be able to provide electrochemical properties for battery performance. Thus, a powder engineered for the optimal balance between flowability and cohesion in a powder deposition process does not necessarily result in the kind of electrochemical performance necessary for a decent battery.

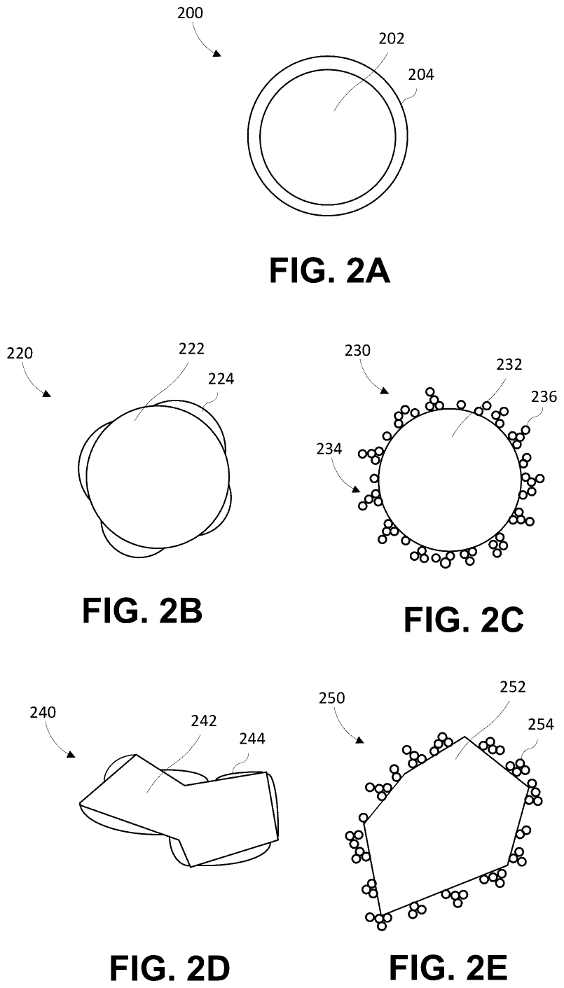

For example, a relatively higher concentration of binder in loose dry powder electrode material has been shown to result in a balance of flowability and cohesion when mixed using relatively higher shear forces. The resulting morphology is a thick coating of binder around the active electrode material particles that is ideally flowable. FIG. 2A shows an example flowable dry powder electrode material particle 200, in accordance with one or more examples. In this example, dry powder electrode material particle 200 includes active material particle 202 and a thick binder layer 204. In one example, thick binder layer 204 was produced by dry mixing active material, 4% binder, and conductive additives. The thick binder layer 204 coats the entire surface of active material particle 202, which promotes flowability; however, thick binder layer 204 prevents sufficient electrolyte access to active material particle 200 and, thus, inhibits ionic conduction. Further, the electrode layers that dry powder electrode material particle 200 produces tend to be dense with binder filling much of the space between particles that would ideally be occupied by electrolyte.

Accordingly, after several trials isolating changes to these variables, the binder concentration and shear forces of the dry mixer were reduced to produce active material particles with a partial binder coating or binder dusting. These trials were conducted using PVDF as the binder resulting in the PVDF being sufficiently limited as a surface adherent to the active material particle upon binder activation to enable sufficient electrolyte penetration throughout the electrode layer.

FIG. 2B shows an example morphology of dry powder electrode material particle 220, in accordance with various embodiments. In this example, dry powder electrode material particle 220 includes spherical active material particle 222, such as cathode active material NMC, with partial binder coating 224. Similarly, FIG. 2D shows an example morphology of dry powder electrode material particle 240, in accordance with various embodiments. In this example, dry powder electrode material particle 240 includes amorphous active material particle 242, such as cathode active material LFP, with partial binder coating 244.

The partial binder coating 224, in one embodiment, was produced by dry mixing active material, 2% PVDF, and conductive additives at relatively lower shear forces. The lower shear forces exerted on the active material particles and lower binder concentration resulted in a partial binder coating where the shear forces were still great enough to cause the binder particles to deform and coalesce with the appearance of melted wax. In one example, X-ray photoelectron spectroscopy (XPS) analysis revealed partial binder coating 224 to cover roughly 60-70% of the surface of active material particle 222. Accordingly, dry powder electrode material particle 220 does not flow as well as dry powder electrode material particle 200 yet has superior electrochemical properties. For example, partial binder coating 224 sufficiently limits the PVDF to a surface adherent to the active material particles after compaction and binder activation resulting in sufficient space (e.g., voids, cavities, etc.) between active material particles in the electrode layer for electrolyte penetration.

FIG. 2C shows an example morphology of dry powder electrode material particle 230, in accordance with various embodiments. In this example, dry powder electrode material particle 230 includes spherical active material particle 232, such as cathode active material NMC, with porous binder coating 234. Similarly, FIG. 2E shows an example morphology of dry powder electrode material particle 250, in accordance with various embodiments. In this example, dry powder electrode material particle 250 includes amorphous active material particle 252, such as cathode active material LFP, with porous binder coating 254.

Porous binder coating 234 is a matrix of nano PVDF particles 236 (200-500 nm in diameter). The matrix, in one embodiment, may appear as a fluffy dusting of nano PVDF particles 236 and can range from areas of no coverage on the surface of active material particle 232 to areas of multiple nano PVDF particles 236 thick. In one embodiment, the adjective “fluffy” is used to characterize a porous hard-spongelike layer composed of many nano PVDF particles 236 attached to each other surrounding active material particle 232. Porous binder coating 234, in one embodiment, was produced by dry mixing the active material, 2% nano PVDF, and conductive additives at even lower shear forces compared to FIG. 2B. XPS analysis of these particles reveals a 70-90% binder surface coverage of active material particle 232, which is higher than active material particle 220 described above in FIG. 2B. Although this specific trial was conducted with nano PVDF, the scope of this disclosure should not be construed as limited to PVDF and other binder particles could also be used.

Accordingly, the higher shear forces exerted in the mixing of particles described in FIGS. 2A-2B causes the binder to at least partially deform and mold to the surface of the active material particles (202, 222). Conversely, the relatively lower shear forces exerted when mixing dry powder electrode material particle 230 cause the nano PVDF particles 236 to adhere to the surface of active material particle 230 and to each other (to form a three-dimensional matrix of particles) without complete deformation. This adherence without complete deformation causes the porous matrix layer of porous binder coating 234 described above. Accordingly, porous binder coating 234 causes increased friction having a Hausner ratio of roughly 1.38-1.45 and, thus, dry powder electrode material particle 230 does not flow as well as dry powder electrode material particles (202, 222) yet has superior electrochemical properties.

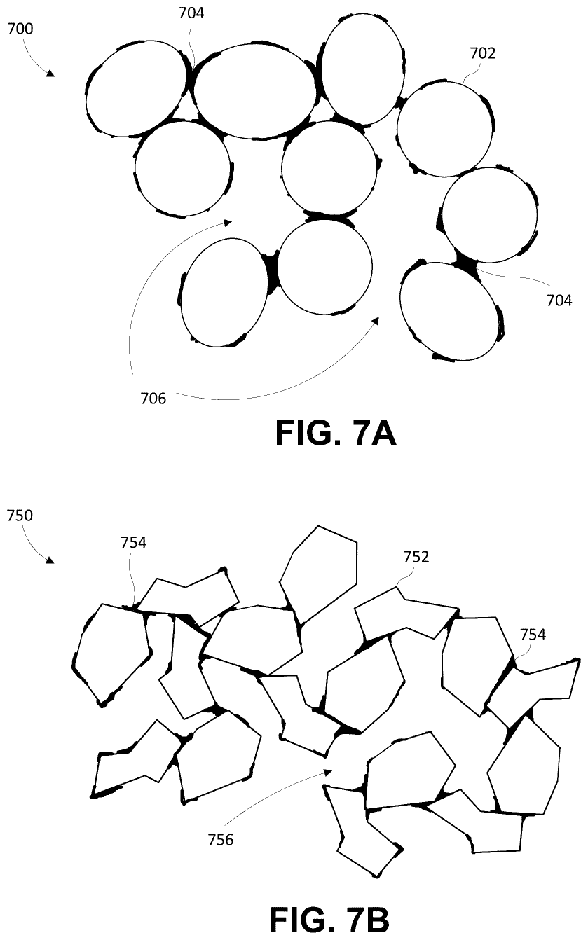

As in FIG. 2C, porous binder coating 234 also sufficiently limits the PVDF to a surface adherent of the active material particles after compaction and binder activation resulting in sufficient space (e.g., voids, cavities, etc.) between active material particles in the electrode layer for electrolyte penetration. This will be described in further detail with respect to FIGS. 7A-7B. Additionally, the resulting morphology, its porous nature, and spread of the binder layer result, in one embodiment, in an increase in ionic conductivity due to capillary forces that encourage electrolyte penetration toward and access to active material particle 232.

In one embodiment, a small amount of solvent can be added during the mixing process as a process aid. The solvent is then removed during the later stages of the mixing process or immediately after. The result is increased binding efficiency as a result of modifying the shape and structure of the binder. The solvent can be removed through mild heating (80-160° C.), thus “locking in” a modified structure of the binder to create a dry active material powder. This dry active material powder can then be deposited onto a current collector, as described elsewhere herein.

The dry powder used to produce the dry powder electrode layers can be produced using any suitable thermoplastic binder compositions other than PVDF binder. To achieve optimal balance between flowability and cohesion of the dry powder in order to produce a uniform layer, a hybrid binder composition may be used. In one example, the hybrid binder composition may comprise a thermoplastic binder and a thermally curable binder. In another example, the hybrid binder composition may comprise a thermoplastic binder and a UV curable binder. In another example, the hybrid binder composition may comprise a thermally curable binder and a UV curable binder. In another example, the hybrid binder composition may comprise two or more UV curable compositions, and each is cured by UV radiation at a wavelength different from each other. In yet another example, the hybrid binder composition may comprise one or more B-stage binder compositions which are partially cured, i.e., in the B-stage state. In various implementations, one or more of the components of the hybrid binder composition can be selectively cured or partially cured to tune the flowability and cohesion of the dry powder during the dry powder mixing process as described above or the dry powder electrode manufacturing process as illustrated below.

### Systems for Manufacturing a Dry Powder Electrode

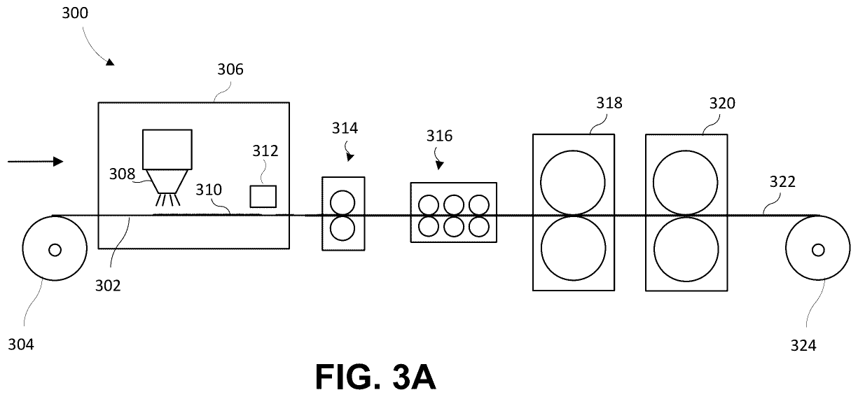

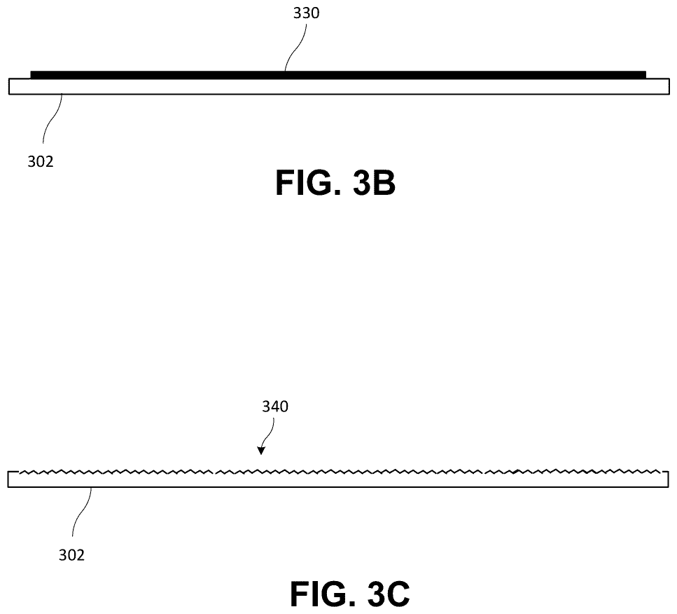

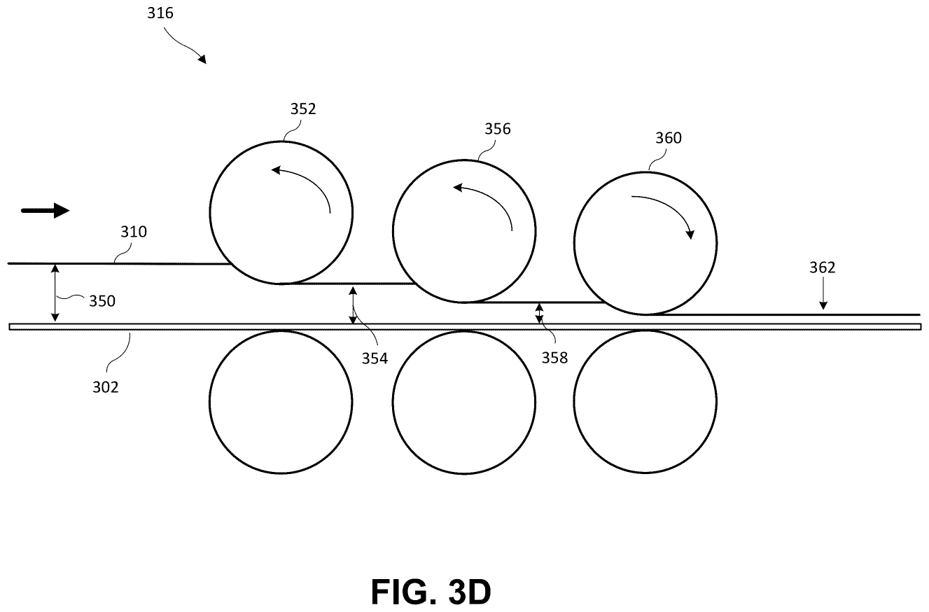

FIG. 3A shows dry powder electrode manufacturing platform 300, in accordance with one or more embodiments. Platform 300 includes moving current collector web 302, first web roller 304, powder deposition station 306, smoothing station 314, conditioning station 316, first calender 318, second calender 320, and second web roller 324.

In various embodiments, platform 300 is a roll-to-roll manufacturing system where the build substrate or current collector web 302, in this example, is unwound by first roller 304 and, after the electrode layer is completed, is rewound by second web roller 324. The end product of platform 300 is a roll of electrode (i.e., either cathode or anode).

Accordingly, first web roller 304 unwinds current collector web 302 and powder dispensing device 308 of powder deposition station 306 deposits or pours dry powder electrode material 310 onto moving current collector web 302. As described above, dry powder electrode material 310 is flowable enough to be poured from powder dispensing device 308 yet cohesive enough not to spill off the sides of current collector web 302; however, it is a loose powder that remains loose on moving current collector web 302 after being deposited.

In one embodiment, moving current collector web 302 is engineered to receive a spreadable powder, encourage cohesiveness of the deposited dry powder electrode material 310, and facilitate spreading. FIG. 3B shows primer layer 330 deposited on the surface of current collector web 302, in accordance with one or more embodiments. Besides supplementing the adhesiveness between the active material and current collector, the roughness of primer can be tuned and leveraged to improve the dry deposition of electrode powder on the current collector. Primer layer 330 may comprise a polymer binder and electronically conductive materials such as carbon black, graphite, carbon nanotube, graphene, conducting polymer and the like. The primer layer may have a thickness in a range of 1-30 microns and surface roughness of Ra in range of 0.2-0.5 microns and Rz in range of 1-3 microns. In another example, FIG. 3C shows roughened surface 340 of current collector web 302, in accordance with one or more embodiments. Roughened surface 340 could be mechanically roughened using, for example, sandpaper or chemically etched. In each of these examples, characteristics of the surface treatments are chosen for their ability to increase friction between the deposited dry powder electrode material 310 and the moving current collector web 302. Roughened surface 340 may have a surface roughness of Ra in range of 0.5-1 microns and Rz in range of 2-5 microns.

Powder deposition station 306 additionally includes gauging or spreading device 312, such as a doctor blade or smoothing roller (i.e., counterclockwise rotating roller) configured to perform an initial spreading of dry powder electrode material 310 and set an initial powder layer height. After the initial spreading, moving current collector web 302 carries dry powder electrode material 310 to, in one embodiment, smoothing station 314 that includes one or more smoothing rollers. Upon being poured onto current collector web 302, dry powder electrode material 310 is loose pile of powder of relatively varying thickness that may or may not cover the width of current collector web 302. Additionally, this loose pile of powder may contain other surface imperfections, such as spots, valleys, holes, and so forth after being poured and initially spread. It is critical that these imperfections and non-uniformities are removed. Layer imperfections and other non-uniformities, such as uneven thicknesses, in a battery electrode lead to poor battery performance and shortened cycle life and, therefore, must be removed. Accordingly, one or more smoothing rollers redistribute a portion of the powder to level the dry powder electrode material 310, fill in holes, or otherwise remove non-uniformities.

After smoothing station 314, moving current collector web 302 carries dry powder electrode material 310 to conditioning station 316, in this example, that includes one or more smoothing rollers. As described above, dry powder electrode material 310 is a flowable powder that does not lend itself well to being moved, transported, or subject to vibration as it is carried down a moving web. Additionally, it is critical that dry powder electrode material 310 layer is sufficiently dense and uniform for battery performance. Additionally, dry powder electrode material 310 layer needs to arrive at the final compaction stage dense and uniform. Thus, in various embodiments, steps are taken to maintain handleability and reasonable cohesiveness of dry powder electrode material 310 before it is compacted into an electrode at the calendering stage.

FIG. 3D shows conditioning station 316, in accordance with one or more embodiments. In this example, conditioning station 316 includes first roller 352, second roller 354, and third roller 356. These rollers can be conditioning rollers, smoothing rollers, or a combination of both. Smoothing rollers are counter-rotating rollers, which rotate backward (i.e., against the direction of the moving web as indicated by the arrow shown in FIG. 3D) and generally smooth the powder layer by redistributing a portion of the powder and more efficiently arranging the particles. This backfills abnormalities or non-uniformities in the layer. Conditioning rollers are forward-rotating rollers, which rotate in the direction of the moving web (i.e., forward) and effectively operate to compact or densify the dry powder electrode material 310 layer. In one embodiment, each conditioning roller imparts between 3-7% compaction on the powder layer, but greater compaction from these rollers is possible. Both smoothing rollers and conditioning rollers aid in the removal of void space between particles. Conditioning rollers achieve this primarily by weak or mild compaction and smoothing rollers achieve this primarily by more efficiently organizing the particles relative to each other. This handleability can be achieved by any form of physical or chemical adherence to the primer layer or interparticle bonding including but not limited to thermal activation of binder or heat, sintering of polymeric particles, chemical reaction of the binder with air humidity, induced bonding forces by surface tension from exposure to any form liquid or vapor of water, volatile solutions or solvent, ultraviolet or microwave initiation of photosensitive radicals in form of monomers or polymers, or Brownian settlement of small particles between interstitial spaces of powder particles.

As mentioned above, steps are taken to maintain handleability and reasonable cohesiveness of dry powder electrode material 310. This includes ensuring that the powder layer is smooth and uniform in width across current collector web 302 and down its length. In one embodiment, these steps include a combination of smoothing rollers and conditioning rollers; however, different powder characteristics combined with the desired web speed may require more or less of at least one of the smoothing rollers and conditioning rollers. In this example, moving current collector web 302 carries dry powder electrode material 310 to first roller 352 for conditioning. First roller 352, in this example, performs a first compaction on dry powder electrode material 310 layer, reducing its thickness from first thickness 350 to second thickness 354. Accordingly, dry powder electrode material 310 is then carried to another conditioning roller, second roller 356, that performs a second compaction on the layer, reducing its thickness from second thickness 354 to third thickness 358.

Finally, in this example, dry powder electrode material 310 layer is carried to smoothing third roller 360 that further reduces the thickness of the layer from third thickness 358 to fourth thickness 362. While the example described with respect to FIG. 3D shows two conditioning rollers and one smoothing roller, the three rollers could be all conditioning rollers or any permutation of conditioning and smoothing rollers depending on powder characteristics and web speed requirements. Additionally, the number of rollers is also adjustable (i.e., more or less than 3 rollers) depending on powder characteristics and web speed requirements Accordingly, the result of conditioning station 316 is a smooth and uniform loose powder layer that has been conditioned for final compaction and binder activation. Accordingly, the one or more conditioning rollers of conditioning station 316 help densify the loose powder layer to help keep it cohesive as it moves and vibrates down moving current collector web 302 prior to compaction. While the powder layer remains loose on moving current collector web 302 until final compaction by one or more calenders, void space between particles of dry powder electrode material 310 layer has been reduced, thereby, increasing the internal friction between individual particles to form a weakly internally locked particle network that is more conducive to compaction.

Further, it can be difficult, depending on the characteristics of dry powder electrode material 310, to obtain a smooth and uniform electrode layer when fully compacting a loose powder layer with a single calender and no conditioning. In these instances, the resulting compacted layer often includes areas of greater compaction and areas of lesser compaction characteristic of a wave or crosshatch pattern. Thus, in various embodiments, the loose powder layer benefits from conditioning and/or progressive compaction where each compaction stage provides additional compaction to the powder layer.

After conditioning, dry powder electrode material 310 layer is compacted by first calender 318 and then by second calender 320 to generate electrode layer 322, in accordance with one or more embodiments. The pressure applied to dry powder electrode material 310 layer by first calender 318 and second calender 320, in one embodiment, is greater than the pressure applied by conditioning station 316 and is configured to target between 20-40% electrode layer porosity, which is comparable to or less than traditional wet casted electrode porosities. These porosities are achieved by calender pressures of 10-30 MPa. Additionally, at least one of the first calender 318 and second calender 320 is heated to activate the binder of dry powder electrode material 310 to generate electrode layer 322. In one embodiment, at least one of the first calender 318 and second calender 320 is heated to a temperature between 150-210° C. In one embodiment, a first temperature is used for the upper or top calender roller (e.g., 150-210° C.) and a second temperature is used for the lower or bottom calender (e.g., 90-160° C.). Accordingly, electrode layer 322 on moving current collector web 302, in this embodiment, is then rewound into a roll by second web roller 324. In some embodiments, after conditioning, dry powder electrode material layer 310 is compacted by only one calender. In other embodiments, after conditioning, dry powder electrode material layer 310 is compacted by three or more calenders.

Dry powder electrode manufacturing platform 300 may include additional features or process steps to improve the handleability and cohesiveness of dry powder electrode material layer 310 and to address other issues such as powder sticking on the calendering rollers, splitting or breaking apart of the dry powder electrode material, which can result in unacceptable defects and non-uniform part fabrication of the dry powder electrode. To address these issues, in one embodiment, a lubricating or wetting agent may be applied to the dry powder electrode material layer 310 to increase the cohesiveness of the dry powder electrode material layer prior to the compaction by the calendering rollers. For example, a lubricating station may be included between the conditioning station 316 and calender 318. In one embodiment, the lubricating station provides a steam generated from water which helps improve cohesiveness of the dry powder electrode material layer and thus prevent sticking and/or splitting of the dry powder electrode material, leading to uniform compaction. Any suitable lubricating agents including organic materials (e.g. organic solvents) and other materials added to water may be used to improve the cohesion and uniform compaction of the dry powder electrode material. The amount of lubrication agent applied to the dry powder electrode material can be less than 10 wt %, preferably less than 5 wt %. In some implementations, the lubricating agents can be added into the dry powder electrode material during the dry powder manufacturing process. In a particular example, one or more B-stage binders are included in the dry powder electrode material, wherein B-stage binders are partially cured and serve as the lubricating agents. In another example, the lubricating agent can serve as an activation agent to activate binder curing.

Additionally, dry powder electrode manufacturing platform 300 may use heat separate from calendering to improve the handleability and cohesiveness of dry powder electrode material layer 310 moving current collector web 302. For example, heat could be applied directly to the currently collector web, such as from below, to the dry powder electrode material layer 310 from above, or some combination thereof. Further, the application of heat and binder activation could be wholly separate from calendering (i.e., the one or more calenders only apply pressure) or dry powder electrode manufacturing platform 300 could apply heat in addition to the application of heated calenders.

In various embodiments, the dry powder electrode manufacturing platform 300 may include a curing station between the conditioning station 316 and calender 318. When a hybrid binder comprising one or more of thermoplastic binder, thermally curable binder and UV curable binder is used, one or more of the components of the hybrid binder can be selectively cured or partially cured by the curing station to improve the cohesion and handleability of the dry powder electrode material layer 310 prior to the compaction by the calenders 318 and 320.

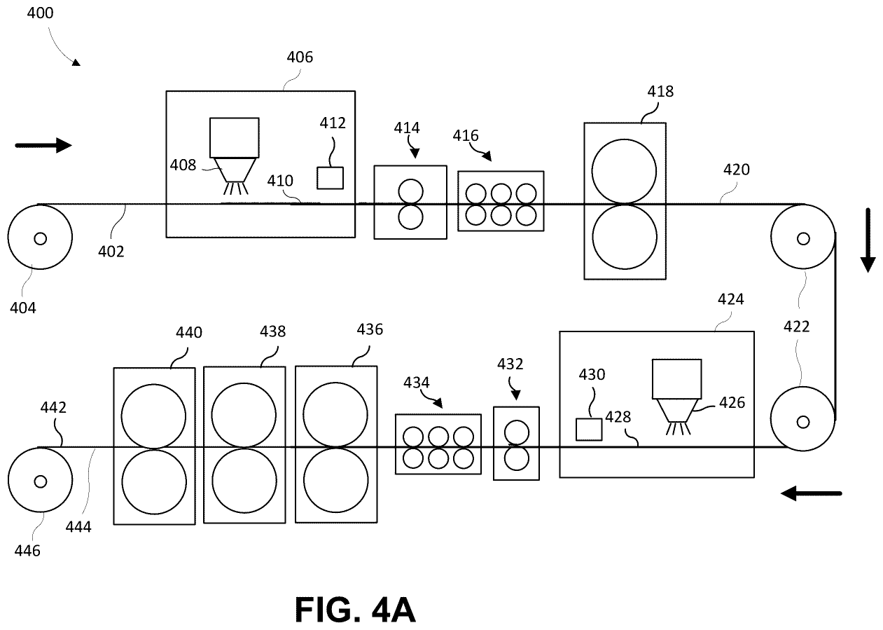

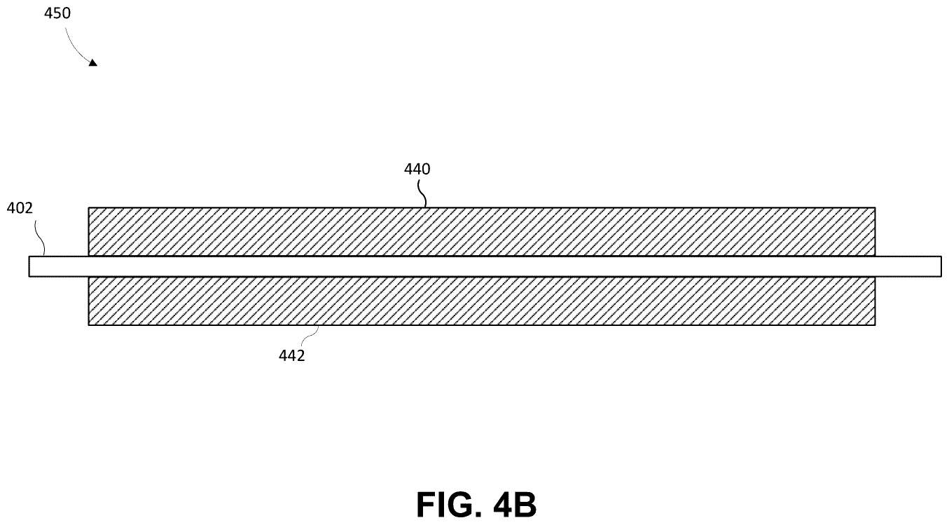

FIG. 4A shows double sided dry powder electrode manufacturing platform 400, in accordance with one or more embodiments. Platform 400 includes moving current collector web 402, unwind web roller 404, first powder deposition station 406, first smoothing station 414, first conditioning station 416, first compaction roller 418, turn rollers 422 to flip web 402, second powder deposition station 424, second smoothing station 432, second conditioning station 434, second compaction roller 436, first calender 438, second calender 440, and rewind web roller 446.

As similarly described above with respect to FIG. 3A-3D, platform 400 is a roll-to-roll manufacturing system. In this example, however, current collector web 402 is unwound by unwind roller 404, a first electrode layer is deposited on a first side of current collector web 402, current collector web 402 turns downward then back horizontal using turn rollers 422 to position the second side of current collector web 402 facing upwards. A second electrode is then deposited on the second side and, after the second electrode layer is completed, current collector web 402 rewound by rewind roller 446 to produce a double-sided electrode further described with respect to FIG. 4B.

Accordingly, unwind roller 404 unwinds current collector web 402 and powder dispensing device 408 of powder deposition station 406 pours first dry powder electrode material 410 onto moving current collector web 402. As described above with respect to FIG. 3A, first dry powder electrode material 410 is carried first to first smoothing station 414 and then to first conditioning station 416 before it undergoes a first densification by first compaction roller 418 to generate partially compacted first layer 420. In this example, first compaction roller 418 could be light pressure calender or one or more conditioning rollers where heat is applied to partially activate the binder in first dry powder electrode material 410 in order to make partially compacted first layer 420 cohesive enough to make the flip without breaking apart. Accordingly, partially compacted first layer 420 is not fully compacted at this stage since partially compacted first layer 420 would then undergo a second full compaction when second dry powder electrode material 428 is fully compacted. Thus, at this stage, partially compacted first layer 420 is only partially compacted and full compaction is performed later when both first dry powder electrode material 410 and second dry powder electrode material 428 are simultaneously calendered.

Partially compacted first layer 420 makes a downward turn around first turn roller 422 then back horizontal, as shown in FIG. 4A, around second turn roller 422 to reveal the uncoated bottom side of moving current collector web 402. As above, moving current collector web 402 eventually reaches second powder dispensing device 426 of powder deposition station 424 where second dry powder electrode material 428 is poured onto now the overturned bottom side of moving current collector web 402. Second dry powder electrode material 428 is then carried to second smoothing station 432 and then to second conditioning station 434 before undergoing densification by second compaction roller 436. In one embodiment, second compaction roller applies an analogous treatment to second dry powder electrode material 428 that was performed on first dry powder electrode material 410 by first compaction roller 418 to balance the compaction of the two layers before final compaction.

In one embodiment, moving current collector web 402 includes a primer layer on each side and first compaction roller 418 and second compaction roller 436 apply heat in way that does not melt the primer on the opposite side. In one embodiment, first compaction roller 418 and second compaction roller 436 are calenders. Accordingly, first compaction roller 418 and second compaction roller 436 each have a top roller and a bottom roller, and the top roller applies a first temperature (e.g., 150-210° C.) to activate the binder and bottom roller applies a second temperature (e.g., 90-160° C.). Referring to FIG. 4A, moving current collector web 402, in one embodiment, includes a primer layer and first dry powder electrode material 410 is deposited thereon. There is also a second primer layer on the bottom side of moving current collector web 402 and it is not desirable to melt or activate the primer that does not have powder deposited there on yet. Accordingly, the bottom roller is set at a lower temperature relative to the top roller to apply less heat to the bottom primer layer. This process can be similarly applied with respect to second compaction roller 436; however, in this instance, compacted first layer 420 is on the bottom side of moving current collector web 402.

Finally, the two layers are simultaneously compacted using first calender 438 and then second calender 440, in accordance with one or more embodiments. As described above, at least one of the first calender 438 or second calender 440 applies heat to each layer to activate the binder of dry powder electrode material 410 and 428, respectively, to generate the respective electrode layers 442 and 444 on both sides of current collector web 402. In one embodiment, at least one of the first calender 438 or second calender 440 is heated to a temperature between 150-210º Celsius. Accordingly, electrode layers 442 and 444 on moving current collector web 402 are then rewound into double-sided electrode roll by rewind web roller 446.

The double sided dry powder electrode manufacturing platform 400 may include additional features or process steps to improve the handleability and cohesion of the dry powder electrode material layer 410 and to address other issues such as powder sticking on the calendering rollers, splitting or breaking apart of the dry powder electrode material, which can result in unacceptable defects and non-uniform part fabrication of the dry powder electrode. For example, lubricating agents and hybrid binders may be employed to enhance the handleability and cohesion of the dry powder electrode material. In one implementation, a lubricating station may be included between the conditioning station 416 and calender 418, wherein the lubricating station applies a lubricating agent such as a steam generated from water to the dry powder electrode material layer 410 to increase the cohesion of the first layer 420 and prevent breaking down of the first layer during flipping through turn rollers 422. Alternatively, the double-sided dry powder electrode manufacturing platform 400 may include a curing station between the conditioning station 416 and calender 418. When a hybrid binder comprising one or more of thermoplastic binder, thermally curable binder and UV curable binder is used, one or more of the components of the hybrid binder can be selectively cured or partially cured by the curing station to improve the cohesion and handleability of the first dry powder electrode material layer 420 to prevent breaking down of the first layer during flipping through turn rollers 422. The lubricating station and curing station may also be included between the conditioning station 434 and calender 436 to improve the cohesion and handleability of the second dry powder electrode material layer 428 prior to the compaction by the calenders 436, 438 and 440.

The end product of platform 400 is a roll of double-sided electrode (i.e., either double-sided cathode or double-sided anode or a bipolar electrode with one side anode and the opposite side cathode), as shown in FIG. 4B. FIG. 4B shows double sided electrode 450, in accordance with various embodiments. In this example, double sided electrode 450 includes first electrode 442 corresponding to first dry powder electrode material 410/420 and second electrode 440 corresponding to second dry powder electrode material 428.

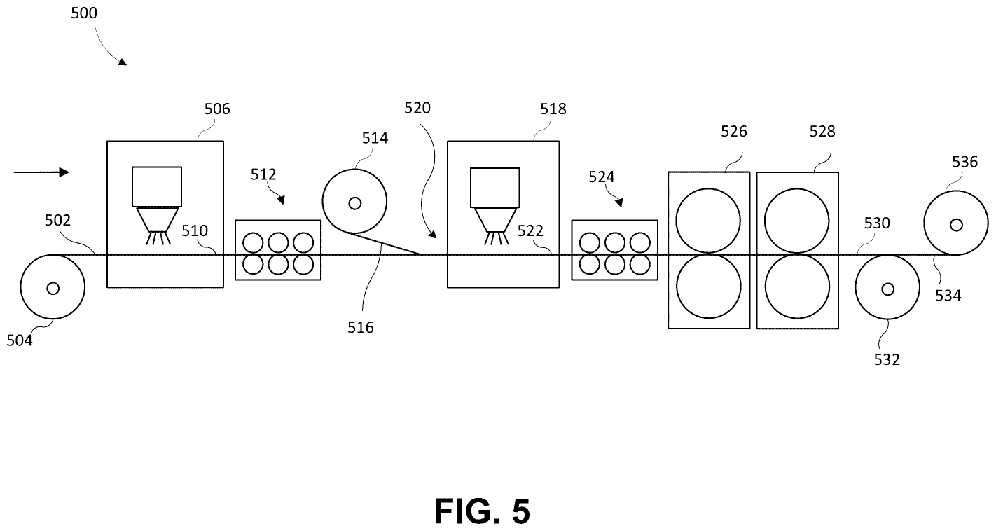

FIG. 5 shows double sided dry powder electrode manufacturing platform 500, in accordance with one or more embodiments. Platform 500 includes moving carrier substrate 502, substrate unwind roller 504, first powder deposition station 506, first conditioning station 512, current collector unwind roller 514, second powder deposition station 518, second conditioning station 524, first calender 526, second calender 528, substrate rewind roller 532, and electrode rewind roller 536.

In this example, substrate unwind roller 504 unwinds a moving carrier substrate 502, such as mylar or aluminum (i.e., without surface treatment or primer), onto which first powder deposition station 506 deposits first dry powder electrode material 510. First dry powder electrode material 510 is then carried through a smoothing station and/or conditioning station 512 to condition the powder layer before compaction, as described above. Unlike the previous examples, however, current collector web 516 is unrolled by current collector unwind roller 514 on top of the conditioned first dry powder electrode material 510 layer to create a stack 520 consisting of carrier substrate 502, first dry powder electrode material 510, and current collector web 516. Accordingly, second dry powder electrode material 522 is deposited on current collector web 516 by second powder deposition station 518 and is subject to smoothing station and/or conditioning station 524, as described above. Although not shown in FIG. 5, platform 500 may additionally include a roller between current collector unwind roller 514 and second powder deposition station 518 for current collector web 516 alignment and tension generation.

At this point before final compaction by first calender 526 and second calender 528, the pre-calendered electrode is a stack that includes carrier substrate 502 at the bottom, a first loose layer of electrode material (i.e., first dry powder electrode material 510), current collector web 516 on top of the first loose layer, and a second loose layer of electrode material (i.e., second dry powder electrode material 522). Accordingly, the two layers are simultaneously compacted using first calender 526 and second calender 528, in accordance with one or more embodiments. As described above, at least one of the first calender 526 or second calender 528 applies heat to each layer to activate the binder of dry powder electrode material 510 and 522, respectively, to generate the respective electrode layers 530 and 534 on both sides of current collector web 516. In one embodiment, at least one of the first calender 526 or second calender 528 is heated to a temperature between 150-210° Celsius. Additionally, as described above, the top and bottom rollers of first calender 526 or second calender 528 could provide different temperatures. For example, a lower bottom roller temperature could facilitate the removal of carrier substrate 502. Finally, carrier substrate 502 is detached from electrode layer 534 and rewound by substrate rewind roller 532 and electrode layers 530 and 534 on either side of current collector web 516 are rewound into double-sided electrode roll by electrode rewind roller 536.

### Method for Manufacturing a Dry Powder Electrode

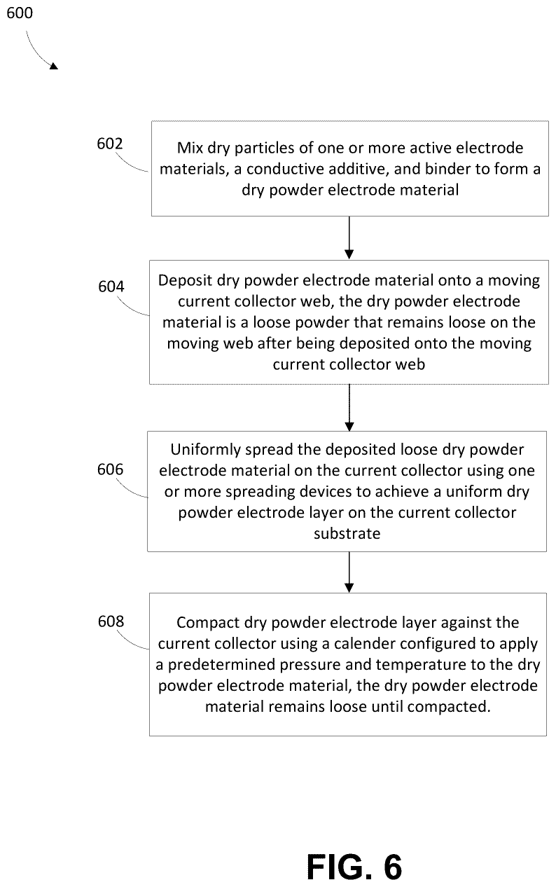

FIG. 6 is a flowchart for method 600 of solvent free manufacturing of a battery electrode, in according with various embodiments. Alternative embodiments may include more, fewer, or different steps from those illustrated in FIG. 6, and the steps may be performed in a different order from that illustrated in FIG. 6.

In this method, active material particles of an anode or cathode, one or more conductive additives, and one or more binder materials are mixed 602 to form a dry powder electrode material. In one embodiment, the one or more binder materials include 0.5-2% PVDF which is mixed with active material particles and conductive additives. In other embodiments, 2-4% PVDF is used. The active material particles and one or more binder materials, in one embodiment, are dry mixed to achieve a partial coating of PVDF over the active material particles that is between 50 and 85%. Additionally, the dry particles are mixed for a duration and at shear forces sufficient to attach 70-100% percentage of fine binder particles onto the surface of the active material particles to achieve a D50 of 7-12 um to achieve a Hausner ratio between 1.3-1.45.

The dry powder electrode material is deposited 604 onto a moving current collector web using a dry powder dispensing device. The dry powder electrode material is a loose powder that remains loose on the moving current collector web after being deposited. In one embodiment, the moving current collector includes a primer layer or a roughened surface to increase friction between the current collector and deposited powder to enhance deposition and powder spreading.

Accordingly, the deposited loose dry powder electrode material is uniformly spread 606 across the moving current collector web using one or more spreading devices to achieve a uniform loose dry powder electrode layer. The one or more spreading devices include smoothing rollers and conditioning rollers to create a smooth, uniform, and relatively more cohesive powder layer as the layer is moved and vibrates down the current collector web. In one embodiment, one or more conditioning rollers each decrease the thickness of the layer though a mild compaction resulting in between 3-7% layer compaction.

The uniform loose dry powder electrode layer is compacted 608 against the current collector web using one or more calenders configured to apply at least one of pressure or heat to the loose dry powder electrode material to activate the one or more binder materials and to form a battery electrode. The loose dry powder electrode material remains loose until compacted by the one or more calenders. In one embodiment, the battery electrode has a porosity between 20-35% after a pressure between 10-30 MPa is applied to the loose dry powder electrode material by the one or more calenders.

### Electrode Characteristics

FIG. 7A shows an example post-compaction morphology of dry powder electrode 700, in accordance with various embodiments. In this example, dry powder electrode 700 includes active material particles 702 held in place by activated binder 704 post calendaring. As described herein, calendaring additionally refers to the application of heat (e.g., 130-210° C.) sufficient to activate or melt the binder discussed with respect to FIGS. 2B-2E to produce activated binder 704. FIG. 7A additionally shows a porous structure that includes cavities 706 represented as spaces or voids in the particle network of electrode 700. In this example, active material particles 702 are spherical particles, such as NMC.

In another example, FIG. 7B shows an example post-compaction morphology of dry powder electrode 750, in accordance with various embodiments. In this example, dry powder electrode 750 includes active material particles 752 held in place by activated binder 754 post calendaring and cavities 756. In this example, active material particles 752 are amorphous shaped particles, such as LFP. In one embodiment, dry powder electrode 700 and dry powder electrode 750 are produced using one of platforms 300, 400, or 500 described above.

In both examples, activated binder 704 and activated binder 754 are limited as surface adherents of their respective active material particles and do not penetrate in cavities 706 or cavities 756. These cavities are not seen in processes using PTFE or wet casting PVDF. In contrast, PTFE fiberizes and these fibers pervade the space between active material particles inhibiting electrolyte penetration. Similarly, wet casting PVDF with NMP fully crystalizes the PVDF, filling the space between active material particles with a hard spongelike structure which inhibits electrolyte penetration. The binder's function is to hold the particles in place to make a cohesive layer and, therefore, the binder would ideally be limited to the contact points between particles in a post-calendered electrode. Limiting the binder to the contact points would ensure (or at least greatly promote) sufficient electrolyte penetration into the electrode layer.

There are multiple factors that may encourage the morphology of dry powder electrode 700 and dry powder electrode 750. One factor is the right amount of binder—not too much that the binder fills an unnecessary volume between particles, but enough to ensure sufficient particle to particle adhesion. Another is binder particle size—small particles may not congeal as readily as larger agglomerates when melted, causing the binder to remain a surface adherent (i.e., keeping the binder from filling in the cavities between particles). Another is mixing intensity or shear force—the shear forces need to be strong enough to get the binder particles to adhere to the active material particle surface, but not too strong that they deform and melt together and fully coat the particle surface. Another factor is calendering pressure and heat—too much pressure and the structure collapses. Accordingly, the resulting morphology of dry powder electrode 700 and dry powder electrode 750, is a porous structure that, in one embodiment, increases ionic conductivity due to capillary forces that encourage electrolyte penetration toward and access to active material particle 702 and 752.

### Systems for Battery Additive Manufacturing

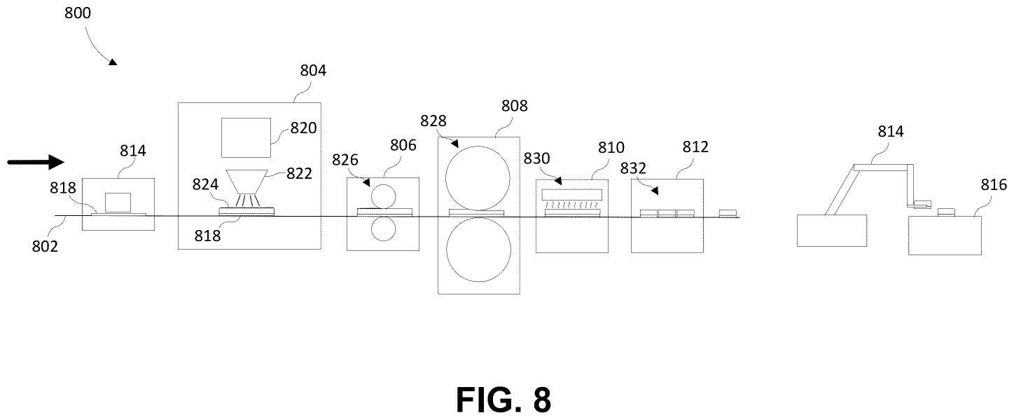

FIG. 8 shows an example of an additive manufacturing (or 3D printing) platform 800 for fabricating batteries using dry powder electrode, in accordance with one or more embodiments. Platform 800 includes a substrate transport system 802, a dry powder deposition station 804, a spreading station 806, a compaction station 808, a pattern curing station 810, a cutting station 812, a transfer system 814, and a build station 816. The substrate transport system 802 is used to transport substrates (i.e., anode or cathode collectors) as needed from station to station in system 800. The transport system 802 may be configured to transport substrates through the system in any suitable manner. In some implementations, the transport system comprises a conveyor system that conveys substrate units 818 from station to station in the system. In other implementations, the substrate is provided as a continuous sheet that is unwound from and rewound onto rolls.

The dry powder deposition station 804 includes the equipment needed to deposit dry powder onto the substrate, such as a hopper 820 for holding the dry powder and a dispensing unit 822 configured to form a powder bed 824 on a substrate 818 with desired thickness and coverage. In various implementations, the dry powder deposition station 804 comprises a binder jetting 3D printing system, although any suitable device or mechanism may be used which can deposit the powder according to desired specifications. The dispensing device 822 and/or the substrate 818 are movable with respect to each other such that the dispensing device 822 can make one or more passes over the substrate/powder bed to deposit one or more layers of the dry powder electrode onto the substrate/powder bed to achieve a desired thickness and/or coverage. The spreading station 806 includes a spreading device 826 configured to uniformly spread the dry powder 824 on or across substrate 818. In some implementations, the spreading device comprises a counter rotating roller. In other embodiments, the spreading device may comprise a blade or similar type of device. Any suitable type of spreading device may be used.

Compaction station 808 is configured to apply a predetermined amount of pressure and/or heat to the powder bed/substrate to achieve desired properties for the deposited powder electrode, such as density, thickness, porosity, and the like. In various implementations, the compaction station 808 may include at least one roller 828 made up of a hardened metal material designed as a cylindrical tube, i.e., a calendering roller. In various implementations, one or more pairs of calendering rollers may be used to form nips through which the powder/substrate is fed. Each pair of calendaring rollers may be configured to apply the same or different amounts of pressure and/or heat to the powder/substrate. For example, one pair of calendering rollers may be configured as a hot calender which applies heat to the powder/substrate that is above a predetermined temperature (e.g., 100-210° C.) while a second pair of calendaring rolls may be configured as a cold calender which applies a lower temperature (e.g. 10-80° C.) to the powder/substrate.

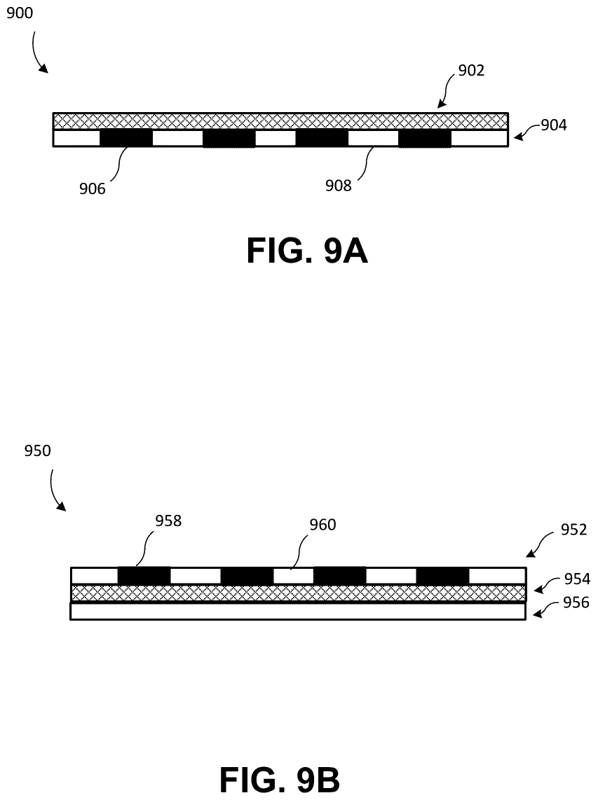

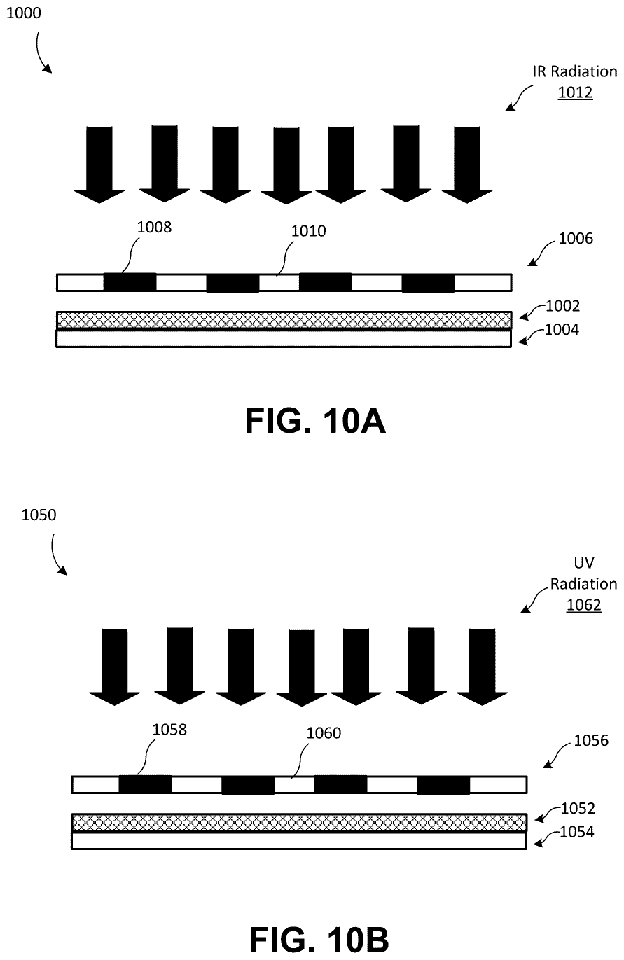

The pattern curing station 810 is configured to perform a defined binder curing process to form printed patterns, i.e. patterned electrodes such as patterned anodes and cathodes. The pattern curing station includes one or more curing devices 830 for curing the binder. The type of device(s) depends on the type(s) of binder used in the powder. Examples of curing devices that may be used include a heating device for curing thermally curable binder, an ultraviolet (UV) lighting device for curing a UV curable binder, and so on. The defined binder curing for forming the printed pattern can be accomplished using various patterning mechanisms, as further illustrated below by FIGS. 9A to 10B.

Once the deposition, spreading, compacting, and defined binder curing processes have been completed, is the printed patterns are provided to the cutting station 812 which singulates the printed patterns into one or more individual battery cell components 832 such as patterned anodes and cathodes of a predetermined size and shape which can be used in the assembly of a battery cell stack at the build station 816. Any suitable cutting device or method may be used to form the electrode/collector components 832.

The transfer system 814 transfers the printed patterns (e.g. patterned anodes and cathodes) to the build station 816. The transfer system 814 includes a transfer device which may be configured to transfer the printed pattern onto a stack of printed pattern layers previously transferred to the build platform. The transfer device can include any suitable type of mechanism for removing the electrode components and transferring the components to the build station, such as pick-up assembly, a vacuum device, an adhesion device, a translation device, etc., to name a few. The build station has a work surface on which cell components can be stacked to form battery cells and multiple cells can be stacked to form batteries. In various implementations, the build station may comprise a substrate, a carrier substrate, an assembly plate, conveyor belt or conveyorized printing platform, as examples.

### Additional Additive Manufacturing Considerations

The present disclosure provides a 3D printing apparatus and a methodology that can be used for any additive manufacturing process based on powder bed printing or binder jetting 3D printing. The 3D printing apparatus and methodology proposed can enable solvent free powder bed printing using dry powder pre-coated with a binder. According to the present disclosure, the process steps of binder deposition and subsequent drying, solvent recovery and/or disposal can be eliminated, thus greatly simplifying the binder jetting 3D printing process, increasing printing throughput and lowering manufacturing cost.

In one embodiment, a solvent free powder bed printing comprises process steps including: (a) depositing the binder coated powder on a powder bed or a substrate, (b) optionally further densifying the deposited layer by a compaction mechanism, (c) forming printed pattern by defined binder curing, and (d) transferring the printed pattern to a build station or a build platform, wherein the process steps of binder deposition and subsequent drying and solvent recovery in the conventional binder jetting 3D printing have been eliminated. In some embodiments, further processing may occur on the printed pattern layer prior to transferring.

In some embodiments, the binder coated powder may comprise one or more of organic binders or inorganic binders or combinations thereof. The organic binder can comprise either a thermally curable composition or a photocurable composition or combinations thereof. In some implementations, the organic binder comprises a thermally curable or thermosetting composition which is applied as a liquid and can harden or cure when heated to bond the particles together. The thermally curable composition can be any binder composition known in the art, e.g., various resin binders comprising monomer, polymer, and curing agent (also known as hardener or cross-linking agent). In some implementations, the organic binder comprises a UV curable composition which is applied as a liquid and can harden or cure when exposed to UV radiation. The UV curable composition can be a composition known in the art, e.g., various UV curable resins comprising monomer, oligomer and photo-initiator. In some implementations, the organic binder may be a hybrid thermally and UV curable binder comprising both thermally curable and UV curable compositions. In some implementations, the organic binder may include two or more UV curable compositions, and each is cured by UV radiation at a wavelength different from each other. In some implementations, the organic binder may include one or more B-stage binder compositions which are partially cured, i.e., in the B-stage state. In some implementations, the organic binder comprises a thermoplastic composition which can melt when heated and harden when cooled to bond the particles together. In some implementations, the binder may remain as part of a printed object post printing process. In other implementations, the binder, e.g., an organic binder may be removed from the printed object by thermal decomposition during the post-printing process, e.g., sintering. In some implementations, the binder may comprise a ceramic precursor, such as polycarbosilane or polysiloxane which can thermally react and become part of the printed object during the post-printing process, e.g., sintering. In some implementations, the binder coated powder may comprise one or more of the binders described above, wherein a surface of the binder coated powder is partially covered by the binder. In some implementations, the binder coated powder may comprise one or more of the binders described above, wherein a surface of the binder coated powder is fully covered by the binder.

In various embodiments, the binder coated powder can be made by any of the various particle coating techniques including but not limited to dry mixing, solvent evaporation, spray coating including spray drying and spray congealing, air suspension coating (also termed as fluidized bed coating), pan coating, centrifugal extrusion and multi-orifice centrifugal process, and the like.

In one embodiment, the binder coated powder is produced by dry powder mixing. For example, the binder coated dry powder materials used to form the dry powder electrode layers can be produced by dry mixing particles of one or more electrode active materials, conductive materials, and one or more binder materials such as PVDF.

In another embodiment, a powder is first formulated into a dispersion, a slurry or an ink, collectively termed liquid dispersion, comprising solid particles of the powder, solvent, binder, dispersant and optionally other additives. The liquid dispersion is then processed by a variety of solvent removal techniques to form the binder coated powder. For example, solvent removal may be accomplished using a liquid extraction device described in recently issued U.S. Pat. No. 11,260,581 (which is incorporated herein by reference), wherein the solvent is removed by using one or more techniques of a pressure differential, a pressure plate, a pressure cuff, a vacuum, or employing a semi-permeable membrane. Alternatively, heat may be applied by the liquid extraction device to extract the solvent via evaporation when solvent of low boiling point or fast drying is used in the liquid dispersion. In another example, solvent removal is accomplished using a spray drying system (spray dryer), wherein the liquid dispersion is atomized into a spray of droplets by pumping the liquid dispersion through a spray nozzle into a heated compartment of the spray dryer, where the solvent of the dispersion is evaporated, yielding dried binder coated powder.

In another embodiment, a powder is formulated into a liquid dispersion with a molten binder, e.g., a binder comprising a thermoplastic composition. The liquid dispersion comprising the molten binder is atomized into a spray of droplets by pumping the liquid dispersion through a spray nozzle into a cooled compartment of a spray congealing system, where the molten binder hardens, yielding dried binder coated powder.

In another embodiment, the binder coated powder is produced using air suspension coating, also termed as fluidized bed coating, solid particles of the powder are suspended by an upward-moving stream of air in a heated coating chamber, where a liquid binder is atomized through nozzles into the chamber and deposited as a thin layer on the surface of the suspended particles, yielding dried binder coated powder. The coating chamber may also be configured with cooling air when a powder is coated with a molten binder like in a spray congealing system.

In some embodiments, the binder coated powder may comprise mono-sized particles or multiple-sized particles, wherein the multiple-sized particles may be mono-distributed, bimodal-distributed or multi-modal distributed. A series of binder coated powders may be produced with powders comprising particles of different sizes and distributions for achieving optimal printing results. For example, a binder coated powder may comprise both large particles which provide necessary printability and smaller particles which fill in the gaps or cavities formed between the large particles, thus increasing the particle packing density, leading to higher density in the final printed object after post-printing process, e.g., sintering. The sintering may also be improved using fine powder comprising smaller particles. However, fine powder comprising smaller particles (e.g., smaller than 5 μm) has poor flowability and is typically difficult to print by binder jetting printing. To address this issue, small particles of fine powder may be agglomerated into larger particles (e.g., 10 to 75 μm) by binder coating processes described above, e.g., by spray coating or fluidized bed coating.

In some embodiments, the binder coated powder can be deposited onto a powder bed or a substrate by a binder jetting 3D printing system. In some implementations, post powder deposition, a compaction mechanism is operated to further increase the packing density of the printed layer. For example, calendering rollers can be employed to compact the printed powder layer, thus achieving higher packing density.

After the deposition of binder coated powder and compaction processes, defined binder curing or binder pattern curing is performed to form the printed pattern. The defined binder curing for forming the printed pattern can be accomplished using various patterning mechanisms.

In some implementations, a patterned heater comprising the printing pattern may be used for selectively curing the pattern area of the deposited powder comprising either thermally curable binder or thermoplastic binder to form the printed pattern. The patterned heater may be formed into the substrate located below the printed powder, as shown in FIG. 9A. FIG. 9A shows example curing process 900 for binder pattern curing, in accordance with various embodiments. In this example, binder coated powder layer 902 is deposited on patterned heater substrate 904 that includes non-pattern areas 906 and pattern areas 908. Additionally, FIG. 9B shows example curing process 950 for binder pattern curing, in accordance with various embodiments. In this example, binder coated powder layer 954 is deposited on substrate 956 and patterned heater 952 (that includes non-pattern areas 958 and pattern areas 960) is placed on top or above binder coated powder layer 954. The patterning resolution may be enhanced by increasing the difference in temperature between the pattern areas (908, 960) which are heated to cure the binder and the non-pattern areas (906, 958) which are cooled to prevent binder curing, wherein the non-pattern area (906, 958) will be removed prior to transferring the printed pattern to a build station or a build platform.

In some implementations, an infrared patterning mask may be used for selectively curing the pattern area of the deposited powder comprising either thermally curable binder or thermoplastic binder to form the printed pattern, as shown in FIG. 10A. FIG. 10A shows example curing process 1000 for binder pattern curing, in accordance with various embodiments. FIG. 10A shows binder coated powder 1002 deposited on top of substrate 1004 with patterning mask 1006 (that includes non-pattern areas 1008 and pattern areas 1010) positioned between binder coated powder 1002 and infrared radiation source 1012. Patterning mask 1006 may be formed using infrared heat insulation or barrier material, wherein the pattern area 1010 of the mask 1006 is open allowing for infrared radiation to pass through and the non-pattern area 1008 of the mask 1006 comprises infrared insulation or barrier material to block the infrared radiation.

In some implementations, to further improve patterning accuracy, a laser melting mechanism may be implemented to form the printed pattern on the deposited powder comprising thermoplastic binder, wherein a laser beam can be programmed to precisely melt the binder in the pattern area of the deposited powder and the printed pattern is formed when the molten binder hardens or solidifies during cooling.

In some implementations, a photo patterning mask may be used for selectively curing the pattern area of the deposited powder comprising a photocurable binder composition, e.g., a UV curable binder composition, as illustrated in FIG. 10B. FIG. 10B shows example curing process 1050 for binder pattern curing, in accordance with various embodiments. FIG. 10B shows binder coated powder 1052 deposited on top of substrate 1054 with patterned mask 1056 (that includes non-pattern areas 1058 and pattern areas 1060) positioned between binder coated powder 1052 and UV radiation source 1062. Similar to the photo patterning mask used in photolithography, the pattern area 1060 of the mask 1056 is open or transparent allowing for light to pass through and the non-pattern area 1058 of the mask comprises opaque material that does not allow the light to travel through.

In some embodiments, defined binder curing or patterned binder curing is controlled so that one or more binder compositions in the deposited powder are partially cured, i.e. in the B-stage state. The presence of B-stage state binder in the printed pattern has the potential advantage of ensuring adequate adhesion between patterned layers when the printed patterns are assembled into a stack in the build station.

In some implementations, defined binder curing is performed on the pattern area of the deposited powder comprising a hybrid binder which includes both thermally curable and UV curable compositions, wherein only the thermally curable binder composition is cured to form the printed pattern, the UV curable binder composition being cured later to provide adhesion between patterned layers during assembly of the printed pattern layers into a stack. Alternatively, the UV curable binder composition is cured to form the printed pattern, and the thermally curable binder composition is cured later to provide adhesion between patterned layers during assembly of the printed pattern layers into a stack.

In some implementations, defined binder curing is performed on the pattern area of the deposited powder comprising a binder which includes two or more UV curable compositions, each composition being cured by UV radiation at a wavelength different from each other. The first UV curable binder composition is cured at a first UV wavelength to form the printed pattern, and the second UV curable binder composition is cured later at a second UV wavelength to provide adhesion between patterned layers during assembly of the printed pattern layers into a stack.

In further implementations, after the deposition of binder coated powder and compaction processes, non-patterning curing is performed on the deposited powder layer, wherein the entire deposited powder layer is cured or partially cured. The cured powder layer is then cut into desired patterns which can be used for assembly of a stack in the build station.

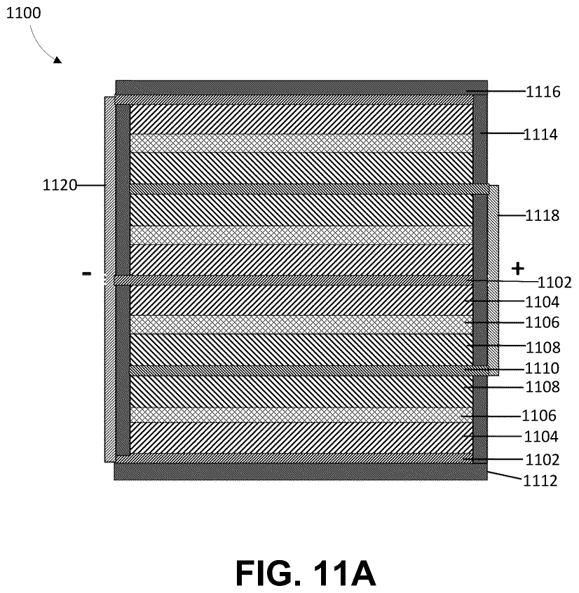

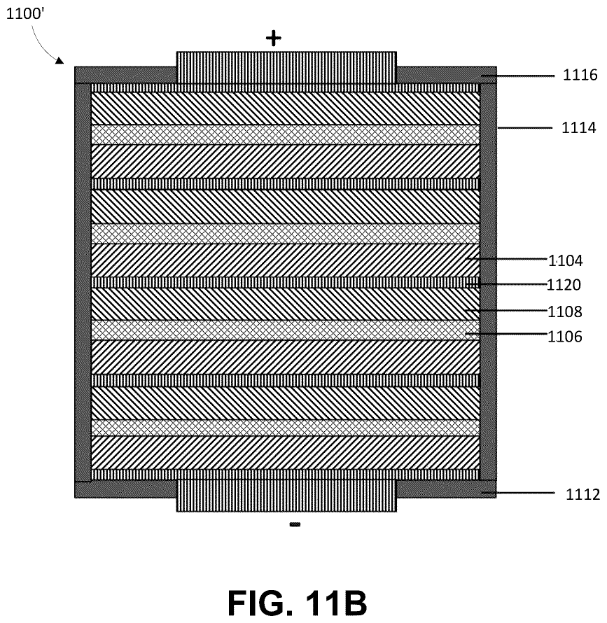

In various implementations, the 3D printing apparatus and methodology that enable solvent free powder bed printing using dry powder pre-coated with a binder according to the present disclosure can be used to form a battery cell comprising a plurality of layers of various functional materials. As shown in FIGS. 11A and 11B, a battery cell comprises one or more layers of an anode, a cathode and a separator interconnecting the anode and the cathode. In some implementations, as illustrated in FIG. 11A, the anode 1104 and cathode 1108 may be formed in a monopolar configuration, wherein anode 1104 is formed on one side or both sides of an anode current collector 1102 and cathode 1108 is formed on one side or both sides of a cathode current collector 1110. A separator 1106 is sandwiched between the monopolar anode 1104 and cathode 1108 to form a battery cell building repeat unit or a sub-cell. Subsequently, the battery sub-cells are stacked together and electrically connected in parallel through external current collector tabs or terminals (1120, 1118) to form a battery cell 1100. The battery cell may include a hermetic seal, enclosure, encapsulation, case or encasing comprising the bottom seal 1112, top seal 1116 and sidewall seal 1114.

In some implementations, as illustrated in FIG. 11B, the anode 1104 and cathode 1108 may be formed in a bipolar configuration, wherein anode 1104 is formed on one side and cathode 1108 on the other side of a common bipolar current collector 1120 to form a bipolar electrode repeat unit. The bipolar electrode repeat units are stacked together with the anode side of a bipolar repeat unit facing to the cathode side of a next adjacent bipolar repeat unit and a separator placed between the anode and the cathode to form a multi-layer bipolar battery cell 1100′, wherein the sub-cells comprising the anode 1104, cathode 1108 and separator 1120 interconnecting the anode and the cathode are electrically connected in series without the use of external current collector tabs.

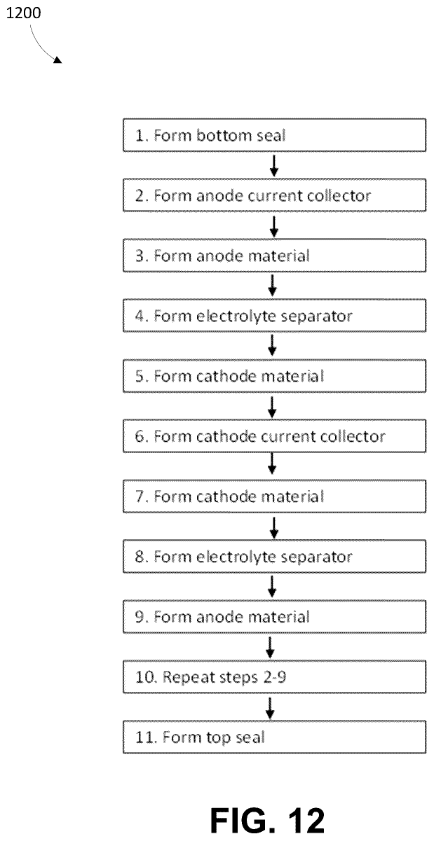

FIG. 12 illustrates a flow chart of a method 1200 of manufacturing a battery cell in accordance with various implementations. In FIG. 12, the method starts with step 1, where a bottom seal (e.g. 1112 of FIGS. 11A and 11B) or enclosure is formed by printing or depositing a layer of a dry powder of seal material pre-coated with a binder. At step 2, an anode current collector (e.g. 1102 of FIG. 11A) is formed on top of the bottom seal with a dry powder of anode current collector material pre-coated with a binder. At step 3, an anode material layer (e.g. 1104 of FIG. 11A) is formed on top of the anode current collector with a dry powder of anode material pre-coated with a binder. At step 4, a separator (e.g. 1106 of FIG. 11A) is formed on top of the anode material layer with a dry powder of separator material precoated with a binder. At step 5, a cathode material layer (e.g. 1108 of FIG. 11A) is formed on top of the electrolyte separator with a dry powder of cathode material precoated with a binder. At step 6, a cathode current collector (e.g. 1110 of FIG. 11A) is formed on top of the cathode material layer with a dry powder of cathode current collector material pre-coated with a binder. At step 7, a cathode material layer is formed on top of the cathode current collector with a dry powder of cathode material precoated with a binder. At step 8, a separator is formed on top of the cathode material layer with a dry powder of separator material precoated with a binder. At step 9, an anode material layer is formed on top of the electrolyte separator with a dry powder of anode material pre-coated with a binder. The method continues by repeating steps 2-9 until reaching the desired layer count of the battery cell. At step 11, a top seal (e.g. 1116 of FIGS. 11A and 11B) or enclosure is formed by depositing a layer of a dry powder of seal material pre-coated with a binder.

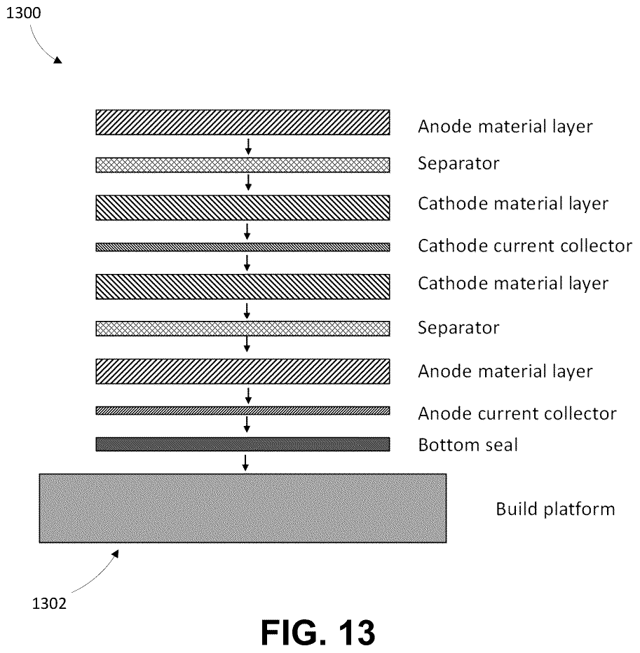

In some implementations, a battery cell comprising a plurality of functional layers of an anode, a cathode and a separator interconnecting the anode and the cathode may be manufactured directly on a build platform, build station or a support structure, optionally on a substrate arranged on top of the build platform. FIG. 13 shows a process 1300, wherein a bottom seal is formed directly on build platform 1302 by depositing a layer of a dry powder of seal material pre-coated with a binder. An anode current collector is then formed on top of the bottom seal with a dry powder of anode current collector material pre-coated with a binder. The manufacturing process continues with the deposition of layers of anode material, separator, cathode material, cathode current collector, etc. until reaching the desired layer count of the battery cell.

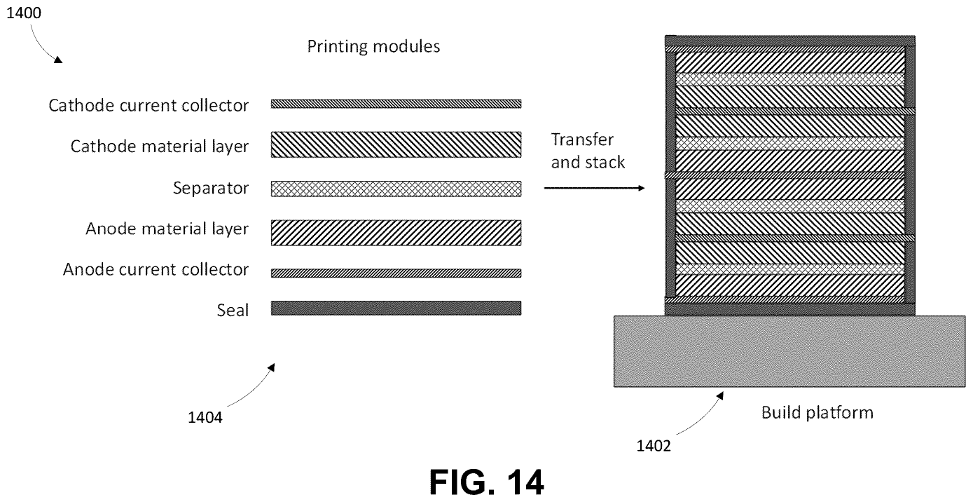

Alternatively, FIG. 14 shows a process 1400, wherein each of the layers of seal, anode current collector, anode material, separator, cathode material, and cathode current collector can be formed separately at different printing modules 1404 and then transferred to build platform 1402, where the battery cell is assembled. For example, each of the functional layers comprises a printed pattern which is formed at a specific printing module (or station) by the solvent free powder bed printing processes as illustrated in FIGS. 8, 9A-10B. The printed patterns are then transferred to the build platform and stacked together following the process flow shown in FIG. 12.

In various implementations, the layers of seal, anode current collector, anode material, separator, cathode material, and cathode current collector may be formed by the solvent free powder bed printing process at different printing speeds depending on the specific requirements of the material, layer thickness and packing density of the layer. For example, the cathode material layer, which is typically thicker than other layers, may require more printing passes or operations, thus be formed at a slower speed. As such, additional printing modules for cathode material printing are needed to speed up the printing process. As another example, it may take more time to complete the transfer, alignment and stacking of a layer on the build platform. In this case, additional build platforms are needed. For volume production, a plurality of printing modules for printing each of the layers of seal, anode current collector, anode material, separator, cathode material, and cathode current collector are arranged with a plurality of build platforms in a way so that the printing speeds of each layer are synchronized with each other and with the speeds of the build platforms to achieve optimal speed or throughput for the entire process.

In some embodiments, a battery cell comprising a plurality of functional layers of an anode, a cathode and a separator interconnecting the anode and the cathode may be manufactured by a hybrid process, where some of the layers of seal, anode current collector, anode material, separator, cathode material, and cathode current collector may be formed by the solvent free powder bed printing process, while the other layers may be formed by alternative methods. For example, the anode or cathode current collector, which are typically much thinner than the anode or cathode, may be formed by inkjet or jetted material printing. Alternatively, the anode or cathode current collector may be formed using conventional copper or aluminum foils, which are cut into predetermined patterns, transferred to the build platform and stacked with other layers of the battery cell by a pick- and-place process. A lithium metal anode can be formed by solvent free powder bed printing using dry lithium powder pre-coated with a binder according to the present disclosure. The lithium anode may be formed using conventional lithium foil, which is cut into predetermined patterns, transferred to the build platform and stacked with other layers of the battery cell by a pick-and-place process.

In various embodiments, a lithium ion battery comprises one or more battery cells, wherein each battery cell includes a plurality of repeated functional layers of an anode, a cathode and a separator interconnecting the anode and the cathode. In some implementations, the anode comprises an anode active material selected from a group consisting of: lithium, lithium powder, molten lithium, semi-liquid lithium, lithium titanium oxide, silicon, silicon oxide, and graphite or combinations thereof. The cathode comprises a cathode active material selected from a group consisting of: lithium cobalt oxide (LCO), lithium manganese oxide (LMO), lithium iron phosphate (LFP), lithium nickel manganese cobalt (NMC), lithium nickel cobalt aluminum oxide (NCA), lithium nickel manganese oxide (LNMO), lithium vanadium oxide (LVO), lithium iron disulfide, silver vanadium oxide, carbon monofluoride, copper oxide, sulfur, or combinations thereof. The separator comprises a separator material selected from any one of polymer, polymer gel, solid state electrolyte including ceramic electrolyte, polymer ceramic composite, or combinations thereof, wherein the separator material may be impregnated with liquid electrolyte to enhance ionic conductivity and provide adequate interface to the anode and the cathode. Each battery cell may also include an anode current collector, a cathode current collector and a hermetic seal. The anode or cathode current collector comprises an electronically conducting material selected from a group consisting of a carbon material, a metal, a semiconductor, a conducting polymer, a polymer composite material. For example, the anode current collector material may be selected from a group consisting of carbon black, activated carbon, graphite, graphene, carbon fiber, and carbon nanotubes, copper, nickel, silver, carbon-polymer composite, metal-polymer composite, or combinations thereof. The cathode current collector material may be selected from a group consisting of carbon black, activated carbon, graphite, graphene, carbon fiber, and carbon nanotubes, aluminum, nickel, silver, carbon-polymer composite, metal-polymer composite, or combinations thereof. The seal comprises a material selected from a group consisting of plastics, epoxy resins, polymer, polymer composite, glass, metals, ceramics, or combinations thereof. In some implementations, the seal can comprise either a thermally curable composition or a photocurable (e.g., UV curable) composition or combinations thereof.

According to another aspect of the disclosure, a solvent free powder bed 3D printing system is provided. The printing system includes a powder deposition device configured to deposit a solvent free binder-coated powder (as described above) onto a substrate or a powder bed. The powder deposition device may be configured to deposit one powder at a time at a desired thickness. In some embodiments, the powder deposition device and/or the substrate/powder bed are movable with respect to each such that the powder deposition device can make one or more passes over the powder bed to deposit one or more layers of the binder-coated powder on the substrate/powder bed. The printing system also includes a pattern curing unit configured to selectively cure the binder-coated powder to form a printed pattern using a curing scheme as discussed above, such as a patterned heater, infrared patterning mask, photo patterning mask, laser curing, etc.

In some embodiments, the pattern curing unit is configured to selectively cure only the thermally curable binder composition of a binder comprising both the thermally curable and UV curable compositions to form the printed pattern, the UV curable binder composition being cured later to provide adhesion between patterned layers during assembly of the printed pattern layers into a stack. In some embodiments, the pattern curing unit is configured to selectively cure only the UV curable binder composition of a binder comprising both the thermally curable and UV curable compositions to form the printed pattern, the thermally curable binder composition being cured later to provide adhesion between patterned layers during assembly of the printed pattern layers into a stack. In some embodiments, the pattern curing unit is configured to selectively cure only a first UV curable composition of a binder to form the printed pattern, wherein the binder comprises two or more UV curable compositions, each composition being cured by UV radiation at a wavelength different from each other; the first UV curable binder composition is cured at a first UV wavelength, and the second UV curable binder composition is cured later at a second UV wavelength to provide adhesion between patterned layers during assembly of the printed pattern layers into a stack.

In some embodiments, the printing system may include a compaction device for applying a predetermined amount of pressure to the binder-coated powder deposited on the substrate/powder bed to compact the powder to a predetermined density. In some implementations, the compaction device can include at least one roller made up of a hardened metal material designed as a cylindrical tube. The printing system may also include a build platform and a transfer device. The build platform has an upper surface with a longitudinal axis extending in a longitudinal direction thereof. In some implementations, the build platform may comprise a substrate, a carrier substrate, an assembly plate, conveyor belt or conveyorized printing platform, for example. The transfer device is configured to transfer the printed pattern from the substrate/powder bed onto the build platform. The transfer device may be configured to transfer the printed pattern onto a stack of printed pattern layers previously transferred to the build platform. The transfer device can include any suitable type of mechanism for removing the printed pattern from the substrate/powder bed and transferring it to the build platform, such as pick-up assembly, a vacuum device, an adhesion device, a translation device, etc., to name a few.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A method of manufacturing dry powder electrodes for lithium-ion batteries comprising:
dry mixing active material particles, one or more conductive additives, and one or more binder materials to form a dry powder electrode material;
depositing the dry powder electrode material onto a moving current collector web using a dry powder dispensing device, wherein the dry powder electrode material is a loose powder that remains loose on the moving current collector web after being deposited;
uniformly spreading the deposited loose dry powder electrode material on the moving current collector web using one or more spreading devices to achieve a uniform loose dry powder electrode layer;
compacting the uniform loose dry powder electrode layer against the current collector web using one or more calenders configured to apply at least one of pressure or heat to the loose dry powder electrode material to activate the one or more binder materials and to form a battery electrode, wherein the loose dry powder electrode material remains loose until compacted.

2. The method of claim 1, wherein the one or more binder materials of the battery electrode are a surface adherent of the active material particles after the application of heat.

3. The method of claim 2, wherein the surface adherent of the one or more binder materials creates a porous structure between the active material particles configured to increase electrolyte penetration and ionic conduction of the battery electrode.

4. The method of claim 2, wherein the dry powder electrode material includes 0.5-2% polyvinylidene fluoride (PVDF).

5. The method of claim 4, wherein the partial coating of PVDF results in a partial crystallization of the PVDF in the battery electrode after the application of heat.

6. The method of claim 4, wherein the active material particles and one or more binder materials are dry mixed to achieve a partial coating of PVDF over the active material particles, wherein the partial coating is an average coverage of PVDF over the active material particles that is between 50 and 85%.

7. The method of claim 1, further comprising:
applying, using a first conditioning roller, a first compaction to the uniform loose dry powder electrode layer that causes a first decrease in a first height of the uniform loose dry powder electrode layer to a second height.

8. The method of claim 7, further comprising:
applying, using a second conditioning roller, a second compaction to the uniform loose dry powder electrode layer that causes a second decrease in the second height of the uniform loose dry powder electrode layer to a third height.

9. The method of claim 8, wherein uniformly spreading the deposited loose dry powder electrode material includes:
applying, using at least one smoothing roller, to redistribute at least a portion of the dry powder electrode material along the layer and remove nonuniformities.

10. The method of claim 1, wherein the dry particles are mixed for a duration and at shear forces sufficient to attach 70-100 percent of fine binder particles onto a surface of the active material to achieve an average particle size of 7-12 μm.

11. The method of claim 1, wherein the moving current collector web further comprises a primer layer configured to receive the dry powder electrode material increase friction between the moving current collector web and the dry powder electrode material.

12. The method of claim 1, wherein the moving current collector web includes a surface treatment configured to receive the dry powder electrode material and increase friction between the moving current collector web and the dry powder electrode material.

13. The method of claim 1, wherein the battery electrode has a porosity between 20-40% after the loose dry powder electrode layer is compacted against the current collector web.

14. A system for manufacturing dry powder electrodes for lithium-ion batteries comprising:
a powder deposition station configured to deposit dry powder electrode material onto a moving current collector web using a dry powder dispensing device, wherein the dry powder electrode material is a dry mixture of active material particles, one or more conductive additives, and one or more binder materials, and wherein the dry powder electrode material is a loose powder that remains loose on the moving current collector web after being deposited;
one or more spreading devices configured to uniformly spread the deposited loose dry powder electrode material on the moving current collector web achieve a uniform loose dry powder electrode layer;
one or more conditioning rollers configured to decrease a thickness of the deposited loose dry powder electrode material on the moving current collector web prior to compaction; and
one or more calenders configured to apply at least one of pressure or heat to the loose dry powder electrode material and compact the loose dry powder electrode layer against the current collector web to activate the one or more binder materials and form a battery electrode, wherein the loose dry powder electrode material remains loose until compacted.

15. The system of claim 14, wherein the one or more binder materials of the battery electrode are a surface adherent of the active material particles after the application of heat.

16. The system of claim 15, wherein the surface adherent of the one or more binder materials creates a porous structure between the active material particles configured to increase electrolyte penetration and ionic conduction of the battery electrode.

17. The system of claim 15, wherein the dry powder electrode material includes 0.5-2% polyvinylidene fluoride (PVDF).

18. The system of claim 17, wherein the partial coating of PVDF results in a partial crystallization of the PVDF in the battery electrode after the application of heat.

19. The system of claim 17, wherein the active material particles and one or more binder materials are dry mixed to achieve a partial coating of PVDF over the active material particles, wherein the partial coating is an average coverage of PVDF over the active material particles that is between 50 and 85%.

20. The system of claim 13, wherein the one or more conditioning rollers include at least a first conditioning roller and a second conditioning roller configured to:
apply, using the first conditioning roller, a first compaction of the deposited loose dry powder electrode layer to decrease the thickness from a first layer thickness to a second layer thickness; and
apply, using the second conditioning roller, a second compaction to the deposited loose dry powder electrode layer to decrease the thickness from the second layer thickness to a third layer thickness.
